(19) United States
(12) Patent Application Publication
(10) Pub. No.: US 2014/0297372 A1
(43) Pub. Date: Oct. 2, 2014

(54) EVALUATION SUPPORT DEVICE AND EVALUATION SUPPORT METHOD

(71) Applicant: FUJITSU LIMITED, Kawasaki-shi (JP)

(72) Inventors: Ryuichi OOKUBO, Hirakata (JP); Masaki Fujinaka, Kobe (JP); Kayoko Hosobe, Hirakata (JP); Hiryu Suzuki, Osaka (JP); Toshihito Nakano, Matsuyama (JP); Yujin Kikkawa, Ota (JP); Hiroshi Sasaki, Meguro (JP)

(73) Assignee: FUJITSU LIMITED, Kawasaki-shi (JP)

(21) Appl. No.: 14/226,950

(22) Filed: Mar. 27, 2014

(30) Foreign Application Priority Data
Mar. 27, 2013 (JP) 2013-067418

(51) Int. Cl. G06Q 10/06

(52) U.S. Cl. CPC G06Q 10/06393
USPC 705/7.39

(57) ABSTRACT

A non-transitory computer-readable recording medium stores an evaluation support program that causes a computer to execute a process including referring to purchase history data of articles in a plurality of salesrooms stored in a storage unit, and identifying a purchase status of articles purchased in a plurality of different salesrooms other than a first salesroom by purchasers included in a group of purchasers who have purchased articles in the first salesroom; and calculating an association degree between the first salesroom and the plurality of different salesrooms, based on whether articles have been purchased in the plurality of different salesrooms as indicated by the purchase status.

### CROSS-REFERENCE TO RELATED APPLICATION

This patent application is based upon and claims the benefit of priority of the prior Japanese Patent Application No. 2013-067418 filed on Mar. 27, 2013, the entire contents of which are incorporated herein by reference.

### FIELD

The embodiments discussed herein are related to an evaluation support device and an evaluation support method for supporting the evaluation of salesrooms.

### BACKGROUND

Conventionally, it is known that in department stores and shopping centers, salesroom evaluation is performed for a salesroom that has been opened in the store for the purpose of increasing sales. When evaluating each salesroom, attention is generally paid to an index value of a single salesroom, such as the sales and area efficiency of each salesroom. The area efficiency is the sales per unit salesroom area.

Furthermore, conventionally, it is known that in department stores and shopping centers, for example, the customers are divided into groups according to the purchase amount of money and the gender of customers based on consumption actions of customers, and services appropriate for the respective groups are provided.
Patent Document 1: Japanese Laid-Open Patent Publication No. 2004-326662
Patent Document 2: Japanese Laid-Open Patent Publication No. 2001-249972

When evaluating a salesroom, if attention is paid only to the index value of a single salesroom, there is a possibility of misjudging the impact that each salesroom has on the entire store such as a department store and a shopping center. For example, when evaluation is performed on each salesroom based on only the sales of the single salesroom, and the sales are low and customers are sent to other salesrooms, the salesroom may be undervalued. Furthermore, for example, when the sales are high but customers are not sent to other salesrooms, the salesroom may be overvalued.

### SUMMARY

According to an aspect of the embodiments, a non-transitory computer-readable recording medium stores an evaluation support program that causes a computer to execute a process including referring to purchase history data of articles in a plurality of salesrooms stored in a storage unit, and identifying a purchase status of articles purchased in a plurality of different salesrooms other than a first salesroom by purchasers included in a group of purchasers who have purchased articles in the first salesroom; and calculating an association degree between the first salesroom and the plurality of different salesrooms, based on whether articles have been purchased in the plurality of different salesrooms as indicated by the purchase status.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates an example of an evaluation support system;

FIG. 2 is a first diagram for describing an association degree;

FIG. 3 is a second diagram for describing an association degree;

FIG. 4 illustrates an example of a hardware configuration of an evaluation support server;

FIG. 5 illustrates a functional configuration of the evaluation support server;

FIG. 6 is a flowchart for describing operations by the evaluation support server according to a first embodiment;

FIG. 7 illustrates examples of purchase history data and analysis data;

FIG. 8 illustrates an example of evaluation data according to the first embodiment;

FIG. 9 illustrates an example of an input screen according to the first embodiment;

FIG. 10 is a first diagram for describing the display of evaluations of each salesroom according to a plurality of index values including an association degree;

FIG. 11 is a second diagram for describing the display of evaluations of each salesroom according to a plurality of index values including an association degree;

FIGS. 12A and 12B are for describing the connection between salesrooms based on the association degree and the simultaneous-purchase ratio;

FIG. 13 is for describing a display of a list of connections between salesrooms based on the association degree and the simultaneous-purchase ratio;

FIG. 14 is for describing the display of changes in the association degree and the sales during predetermined two periods of each salesroom;

FIG. 15 is a first diagram for describing a simulation performed by a simulation execution unit;

FIG. 16 is a second diagram for describing a simulation performed by the simulation execution unit;

FIG. 17 illustrates another example of an input screen according to the first embodiment;

FIG. 18 is a first diagram for describing the support degree;

FIG. 19 is a second diagram for describing the support degree;

FIG. 20 illustrates an example of evaluation data according to a second embodiment;

FIG. 21 illustrates an example of an input screen according to the second embodiment.

FIG. 22 is a first diagram for describing the display of evaluations of each salesroom according to a plurality of index values including a support degree;

FIG. 23 is a second diagram for describing the display of evaluations of each salesroom according to a plurality of index values including a support degree;

FIGS. 24A and 24B are for describing the connection between salesrooms based on the support degree and the simultaneous-purchase ratio;

FIG. 25 is for describing the display of changes in the support degree and the sales during predetermined two periods of each salesroom;

FIG. 26 illustrates an example of evaluation data according to a third embodiment;

FIG. 27 illustrates an example of an input screen according to the third embodiment;

FIG. 28 is a first diagram for describing the display of evaluations of each salesroom according to a combination of the association degree and the support degree; and

FIG. 29 is a second diagram for describing the display of evaluations of each salesroom according to a combination of the association degree and the support degree.

### DESCRIPTION OF EMBODIMENTS

### First Embodiment

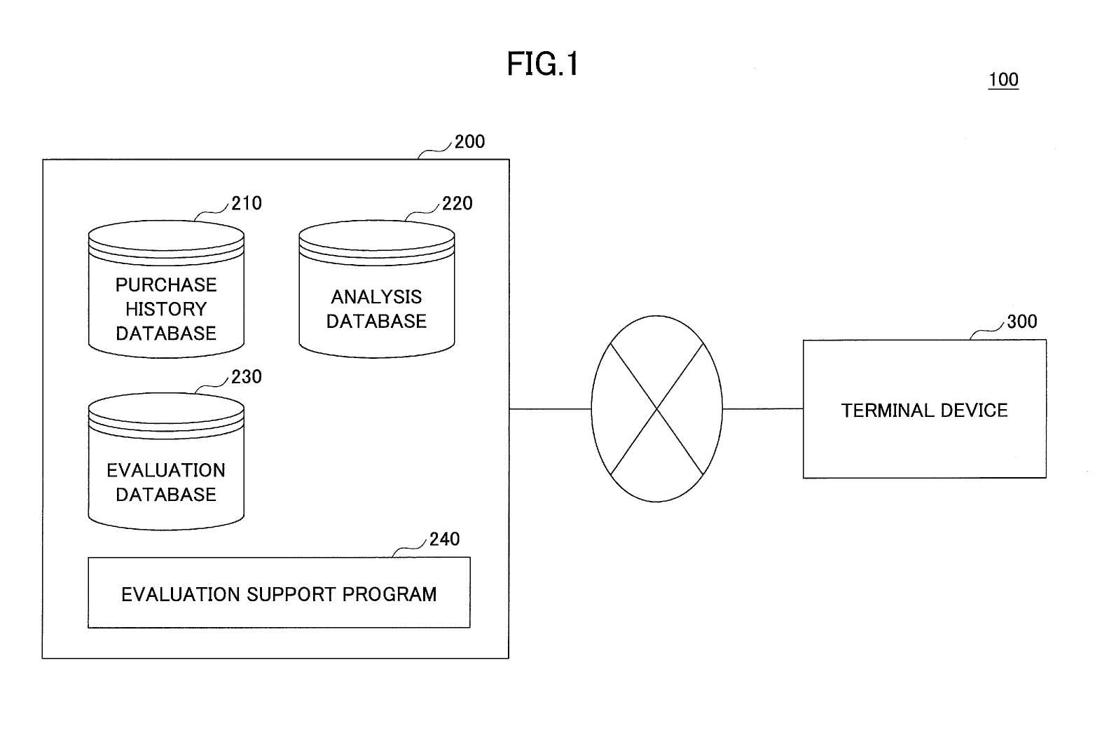

Preferred embodiments of the present invention will be explained with reference to accompanying drawings. FIG. 1 illustrates an example of an evaluation support system.

An evaluation support system 100 according to the present embodiment includes an evaluation support server 200 and a terminal device 300. The evaluation support server 200 and the terminal device 300 are connected via a network.

The evaluation support server 200 and the terminal device 300 according to the present embodiment may be, for example, a desktop computer or a notebook computer. Furthermore, the terminal device 300 according to the present embodiment may be, for example, a tablet terminal.

The evaluation support server 200 according to the present embodiment includes a purchase history database 210, an analysis database 220, and an evaluation database 230, and an evaluation support program 240 is installed.

The evaluation support system 100 according to the present embodiment analyzes, by the evaluation support server 200, the purchase history data of customers in a store such as a department store or a shopping center, generates a screen for displaying the evaluation data of each salesroom in the store, and causes the terminal device 300 to display the generated screen.

In the following description, a facility such as a department store or a shopping center, in which a plurality of salesrooms have been opened, is referred to as a store. Furthermore, a salesroom in the present embodiment may be, for example, each sales floor in the store, or a salesroom that handles merchandise of a particular manufacturer (brand).

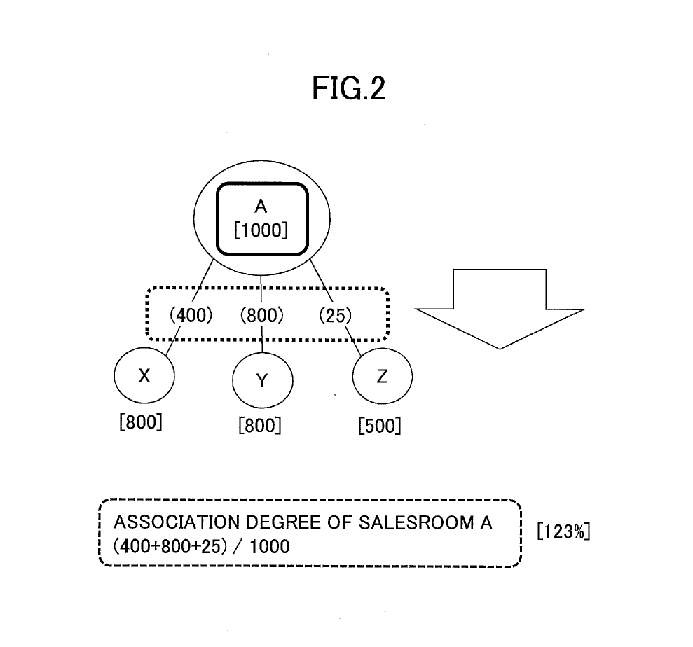

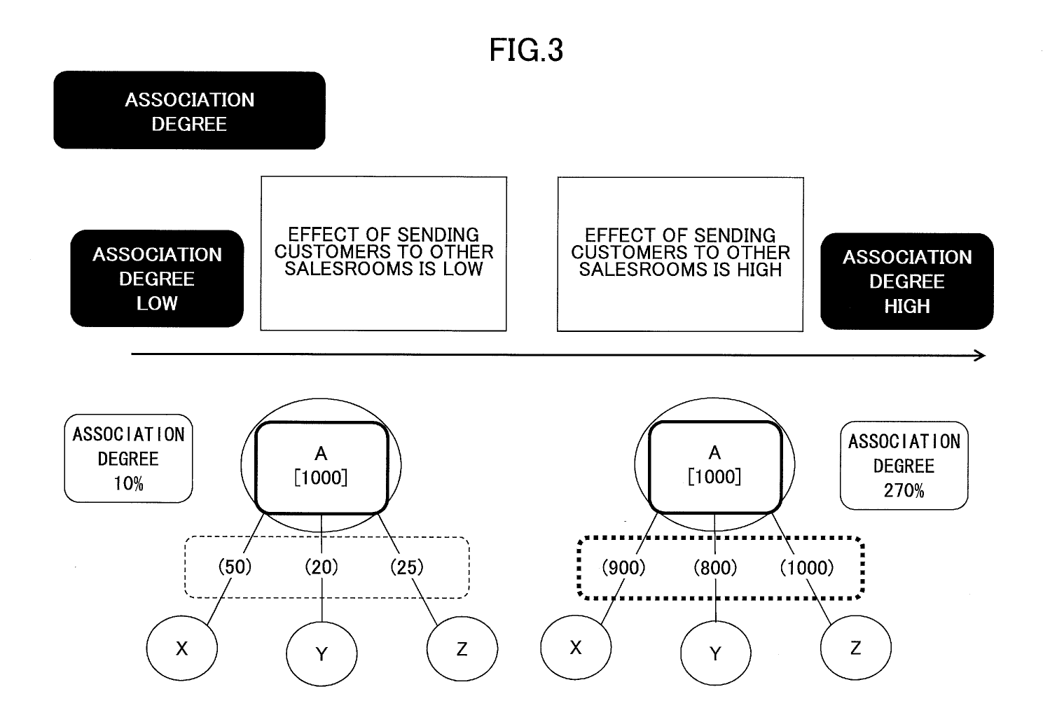

In the following, a description is given of an association degree according to the present embodiment, with reference to FIGS. 2 and 3. FIG. 2 is a first diagram for describing an association degree.

An association degree according to the present embodiment indicates the degree to which a customer, who has purchased an article at a salesroom that is the evaluation target, will purchase an article at another salesroom. Specifically, an association degree according to the present embodiment is calculated by “the total number of customers who have purchased an article of a salesroom that is an evaluation target simultaneously as purchasing an article of another salesroom/the number of customers who have purchased an article at a salesroom that is an evaluation target×100[%]”.

FIG. 2 describes an example where a salesroom A is the evaluation target. In the present embodiment, based on the purchase history data of a store in which the salesroom A is open, the number of customers, who have purchased an article at the salesroom A within a predetermined period, is acquired. Note that the predetermined period may be, for example, one day, one week, one month, or any arbitrary period of time.

Furthermore, in the present embodiment, based on the purchase history data, the total number of customers who have purchased an article of the salesroom A together with an article of another salesroom within a predetermined period, is acquired. Note that in the following description, the act of purchasing an article of a particular salesroom together with an article of another salesroom is expressed as “simultaneous-purchasing an article of a particular salesroom”. Furthermore, in the following description, the number of customers who have simultaneous-purchased an article of a particular salesroom is expressed as “the number of simultaneous-purchasing customers of a particular salesroom”.

In FIG. 2, the number of customers who have purchased an article at the salesroom A is 1000. Furthermore, the number of customers who have purchased an article at a salesroom X, which is in the store where the salesroom A is open, is 800, and among these customers, the number of simultaneous-purchasing customers of the salesroom A who have simultaneous-purchased an article of the salesroom A, is 400.

Similarly, the number of customers who have purchased an article at a salesroom Y is 800, and among these customers, the number of simultaneous-purchasing customers who have simultaneous-purchased an article of the salesroom A is 800. The number of customers who have purchased an article at a salesroom Z is 500, and among these customers, the number of simultaneous-purchasing customers who have simultaneous-purchased an article of the salesroom A is 25 customers. Accordingly, in FIG. 2, the total number of customers who have simultaneous-purchased an article of the salesroom A is 400+800+25=1225 [persons].

In FIG. 2, the number of customers who have purchased an article of the salesroom A is 1000, and therefore the association degree of the salesroom A is 1225/1000×100=122.5%. In the present embodiment, the association degree is obtained by rounding off the numbers less than a decimal point. Accordingly, the association degree of the salesroom A is 123%.

Next, with reference to FIG. 3, a description is given of the method of interpreting the association degree according to the present embodiment. FIG. 3 is a second diagram for describing an association degree.

With reference to FIG. 3, a description is given of a case where the association degree of the salesroom A is 10%, and a case where the association degree of the salesroom A is 270%.

When the association degree of the salesroom A is 10%, the number of simultaneous-purchasing customers of the salesroom A in the salesroom X, the number of simultaneous-purchasing customers of the salesroom A in the salesroom Y, and the number of simultaneous-purchasing customers of the salesroom A in the salesroom Z, are 50, 20, and 25, respectively.

Furthermore, when the association degree of the salesroom A is 270%, the number of simultaneous-purchasing customers of the salesroom A in the salesroom X, the number of simultaneous-purchasing customers of the salesroom A in the salesroom Y, and the number of simultaneous-purchasing customers of the salesroom A in the salesroom Z, are 900, 800, and 1000, respectively.

That is to say, when the association degree of the salesroom A is high, it means that the customer who has purchased an article at the salesroom A is highly likely to purchase an article at salesrooms X, Y, and Z. Therefore, it may be interpreted that a salesroom having a high association degree has a high degree of contribution to the store and has a good influence on the store. For example, if the salesroom A having a high association degree is eliminated from the store, it is considered that the sales of the salesrooms X, Y, and Z will decrease.

Furthermore, when the association degree of the salesroom A is low, it means that the customer who has purchased an article at the salesroom A is hardly likely to purchase an article at salesrooms X, Y, and Z. Therefore, it may be interpreted that a salesroom having a low association degree has a low degree of contribution to the store. For example, if the salesroom A having a low association degree is eliminated from the store, considering the overall store, the sales of only the salesroom A will decrease but it is considered that the impact on the sales of the salesrooms X, Y, and Z is small.

According to the above, the higher the association degree of a salesroom, the higher the effect of sending customers to other salesrooms, and the lower the association degree of a salesroom, the lower the effect of sending customers to other salesrooms.

In the evaluation support system 100 according to the present embodiment, the association degree is calculated at the evaluation support server 200, and according to a plurality of index values including an association degree, a screen expressing the relationship between a particular salesroom and other salesrooms is displayed on the terminal device 300, to provide support for appropriately evaluating a salesroom.

Note that in FIG. 1, it is described that in the evaluation support system 100, the evaluation support server 200 and the terminal device 300 are separate devices; however, the present invention is not so limited. In the present embodiment, the evaluation support server 200 and the terminal device 300 may be included in a single device.

Note that the association degree of the present embodiment is calculated by using the number of purchasing customers; however, the present invention is not so limited. The association degree may be calculated by using, for example, the sales amount (of money) of a single particular salesroom, and the purchase amount (of money) of articles that have been simultaneous-purchased in a simultaneous-purchase salesroom of a particular salesroom (simultaneous-purchase amount). Furthermore, the association degree may be calculated by using an average unit price indicated by the sales amount (of money) of a single particular salesroom/number of sales customers (number of customers who have purchased an article in the single particular salesroom).

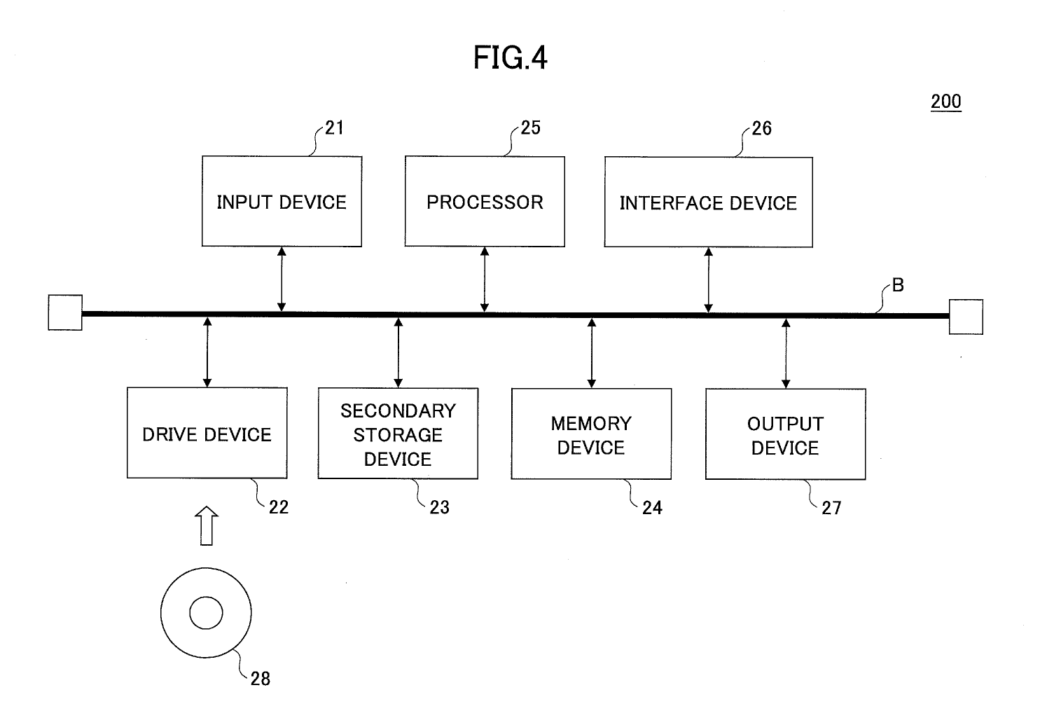

FIG. 4 illustrates an example of a hardware configuration of the evaluation support server 200. The evaluation support server 200 according to the present embodiment includes an input device 21, a drive device 22, a secondary storage device 23, a memory device 24, a processor 25, an interface device 26, and an output device 27, which are interconnected by a bus B.

The input device 21 is, for example, a pointing device and a keyboard, and is used for inputting various signals. The interface device 26 includes a modem, a LAN card, etc., and is used for connecting to a network. The output device 27 may be, for example, a display, which outputs and displays various kinds of information from the evaluation support server 200.

The evaluation support program 240 is at least one of various programs for controlling the evaluation support server 200. For example, the evaluation support program 240 is provided by being distributed in a recording medium 28 and being downloaded from a network. As the recording medium 28 recording the evaluation support program 240, various types of recording media may be used, including a recording medium for optically, electronically, or magnetically recording information such as a CD-ROM, a flexible disk, and a magneto-optical disk, and a semiconductor memory for electronically recording information such as a ROM and a flash memory.

Furthermore, when the recording medium 28 recording the evaluation support program 240 is set in the drive device 22, the evaluation support program 240 is installed in the secondary storage device 23 from the recording medium 28 via the drive device 22. The evaluation support program 240 that has been downloaded from the network is installed in the secondary storage device 23 via the interface device 26.

The evaluation support server 200 stores the installed evaluation support program 240, as well as files and data that are needed. The memory device 24 reads the evaluation support program 240 from the secondary storage device 23 when the computer is started up, and stores the evaluation support program 240. The processor 25 realizes various processes as described below, in accordance with the evaluation support program 240 stored in the memory device 24.

The hardware configuration of the terminal device 300 according to the present embodiment is the same as that of the evaluation support server 200. For example, the evaluation support server 200 according to the present embodiment may be a tablet type computer. In this case, the evaluation support server 200 may include a display operation device having a function of inputting information and a function of displaying information, instead of the input device 21 and the output device 27.

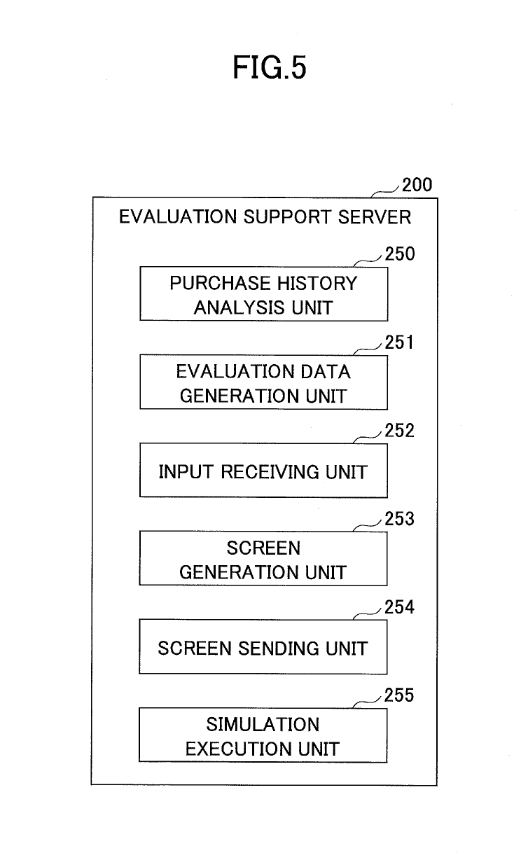

Next, with reference to FIG. 5, a description is given of a functional configuration of the evaluation support server 200 according to the present embodiment. FIG. 5 illustrates a functional configuration of the evaluation support server 200.

The evaluation support server 200 according to the present embodiment includes a purchase history analysis unit 250, an evaluation data generation unit 251, an input receiving unit 252, a screen generation unit 253, a screen sending unit 254, and a simulation execution unit 255. The purchase history analysis unit 250 according to the present embodiment analyzes purchase history data in the purchase history database 210, and creates analysis data used for generating evaluation data. The analysis data is stored in the analysis database 220. The evaluation data generation unit 251 calculates the association degree by using the analysis data, and generates evaluation data including the association degree. The evaluation data is stored in the evaluation database 230.

Note that the purchase history database 210, the analysis database 220, and the evaluation database 230 may be stored in, for example, a predetermined storage area in the secondary storage device 23. Furthermore, in the present embodiment, the evaluation support server 200 includes the purchase history database 210; however, the present invention is not so limited. The purchase history database 210 may be, for example, stored in an external device, and the purchase history analysis unit 250 may acquire the purchase history data by accessing the external device.

For example, the input receiving unit 252 receives input in the input screen displayed on the terminal device 300. Details of the input screen are described below. The screen generation unit 253 generates a display screen for displaying the evaluation data corresponding to input received by the input receiving unit 252, and causes the terminal device 300 to display the display screen. Furthermore, the screen generation unit 253 may also generate, for example, the input screen described above, other than the display screen for displaying evaluation data. The screen sending unit 254 sends the screen generated by the screen generation unit 253 to the terminal device 300, and causes the terminal device 300 to display the screen.

The simulation execution unit 255 refers to the evaluation database 230, and performs a simulation for analyzing the relationship between a salesroom with another salesroom, in a case where a salesroom, which has not yet been introduced in the store, is opened. Details of a process performed by the simulation execution unit 255 are described below.

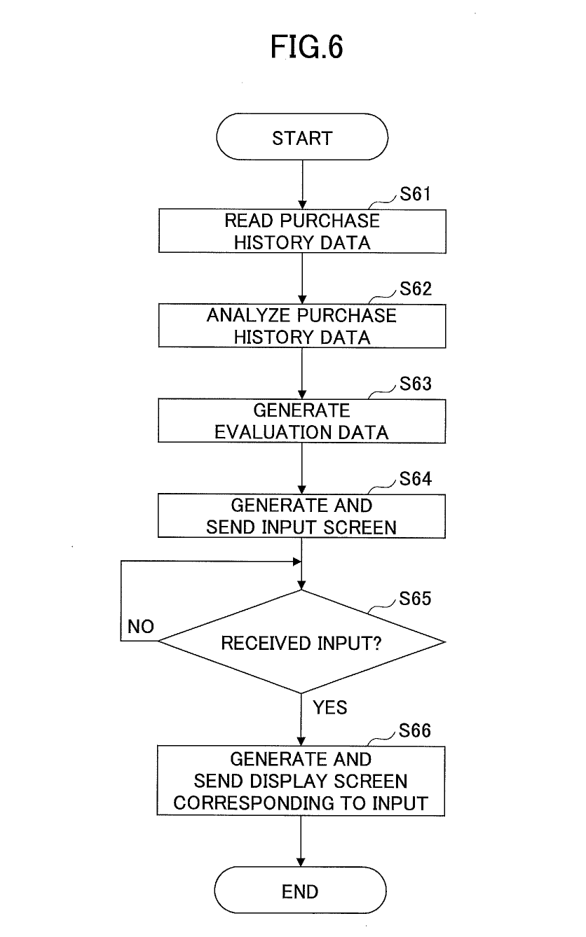

In the following, a description is given of operations by the evaluation support server 200 according to the present embodiment, with reference to FIG. 6. FIG. 6 is a flowchart for describing operations by the evaluation support server 200 according to the first embodiment.

The evaluation support server 200 according to the present embodiment reads purchase history data from the purchase history database 210, by the purchase history analysis unit 250 (step S61). Next, the purchase history analysis unit 250 analyzes the purchase history data, and generates analysis data (step S62). Next, the evaluation data generation unit 251 calculates the association degree, and generates evaluation data including the association degree (step S63).

Next, the screen generation unit 253 generates an input screen for selecting a display pattern of the evaluation data, and sends the input screen to the terminal device 300 by the screen sending unit 254 (step S64). Next, the input receiving unit 252 determines whether an input selecting a display pattern has been received at the terminal device 300 (step S65).

When an input has not been received at step S65, the evaluation support server 200 waits until an input is received. When an input is received in step S65, the screen generation unit 253 generates a display screen corresponding to the display pattern selected at the input screen, sends the generated display screen to the terminal device 300 by the screen sending unit 254 (step S66), and ends the process.

In the following, a process performed by the evaluation support server 200 according to the present embodiment is described in detail.

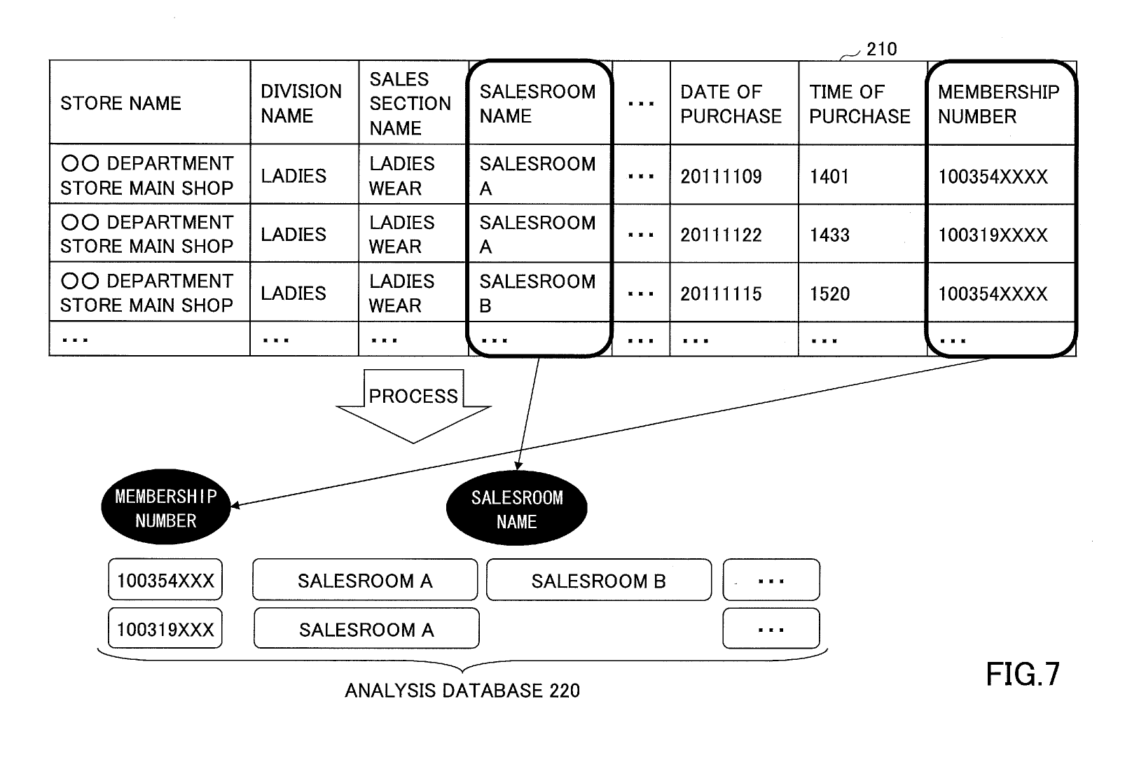

FIG. 7 illustrates examples of purchase history data and analysis data. For example, the purchase history database 210 according to the present embodiment is data in which the department store name that is the store name, the division name in the department store, the sales section name, the salesroom name, the date of purchase, the time of purchase, and the membership number of the customer, are associated with each other.

The analysis database 220 according to the present embodiment is data in which the membership number and the name of the salesroom where the customer has purchased an article, which is identified by the membership number, are associated with each other. The purchase history analysis unit 250 according to the present embodiment acquires the membership numbers of the customers and the salesroom names associated with each of the customers from the purchase history database 210, and generates the analysis database 220 by associating the membership numbers with the salesroom names.

Note that in the analysis database 220 according to the present embodiment, the item associated with the membership number is the salesroom name; however, the item associated with the membership number may be another item included in the purchase history database 210. Specifically, for example, in the analysis database 220, the membership number and the sales section may be associated with each other, or the membership number and the name of the article purchased at the salesroom may be associated with each other. Furthermore, in the example of FIG. 7, the store is a department store; however, the store may be a store other than a department store, such as a supermarket and a convenience store.

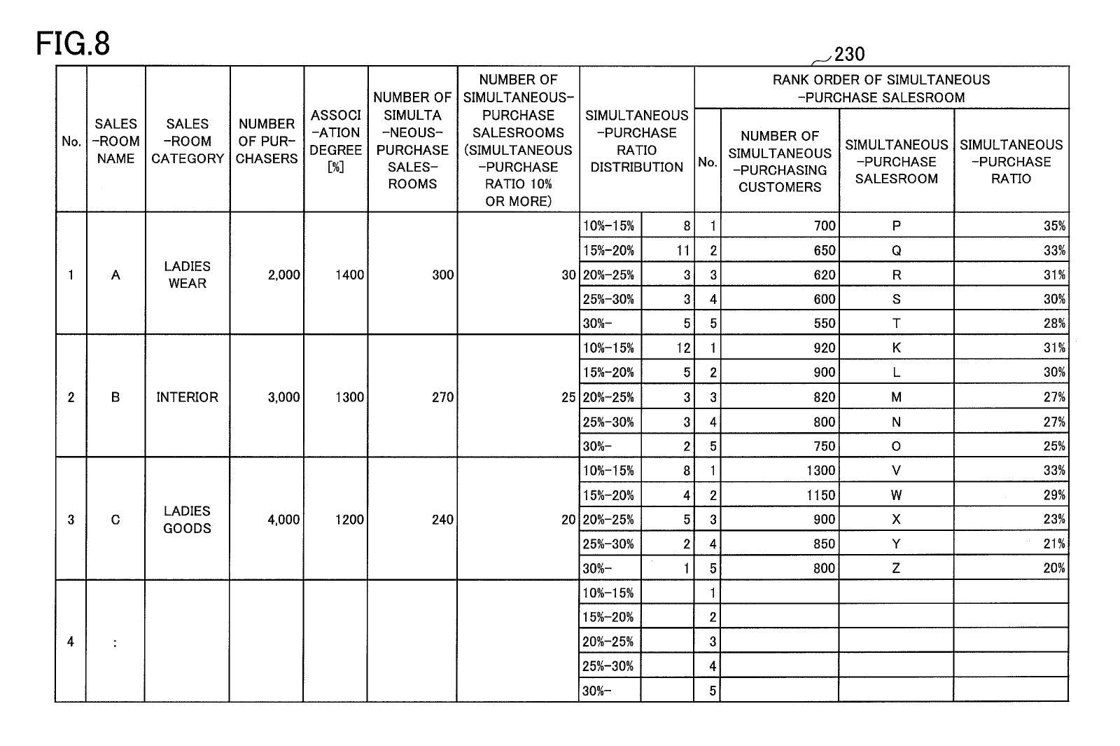

FIG. 8 illustrates an example of evaluation data according to the first embodiment. The evaluation data generation unit 251 according to the present embodiment calculates the association degree for each salesroom based on the analysis database 220. As described above, the association degree according to the present embodiment is calculated by “the total number of customers who have purchased an article of a salesroom that is an evaluation target simultaneously as purchasing an article of another salesroom/the number of customers who have purchased an article at a salesroom that is an evaluation target×100[%]”.

Furthermore, the evaluation data generation unit 251 according to the present embodiment calculates, for each salesroom, the number of purchasing customers per salesroom, the number of simultaneous-purchase salesrooms, the simultaneous-purchase ratio distribution, and the rank order of salesrooms in descending order by the simultaneous-purchase ratio, based on the purchase history database 210.

In the evaluation data 230 illustrated in FIG. 8, for example, the category of the salesroom A is ladies' wear, and the number of customers who have purchased an article at the salesroom A is 2000, and the calculated association degree is 1400%. Furthermore, in the evaluation data 230, the number of salesrooms at which an article has been simultaneous-purchased with an article of the salesroom A (hereinafter, the simultaneous-purchase salesrooms of the salesroom A) is 300. Furthermore, among the simultaneous-purchase salesrooms, the number of salesrooms having a simultaneous-purchase ratio of greater than or equal to 10%, is 30. A simultaneous-purchase ratio is the ratio of the number of customers who have purchased an article at the simultaneous-purchase salesroom, with respect to the number of customers who have purchased an article at a particular salesroom. For example, when the number of customers who have purchased an article at the salesroom A is 2000, and the number of customers who have purchased an article at the simultaneous-purchase salesroom P is 700, the simultaneous-purchase ratio is 700/2000×100=35%.

Furthermore, in the evaluation data 230, the simultaneous-purchase ratio distribution of simultaneous-purchase salesrooms of the salesroom A, is that the number of salesrooms whose simultaneous-purchase ratio is 10% through 15% is 8, the number of salesrooms whose simultaneous-purchase ratio is 15% through 20% is 11, the number of salesrooms whose simultaneous-purchase ratio is 20% through 25% is 3, etc. Furthermore, in the evaluation data 230, the simultaneous-purchase salesroom P has the highest simultaneous-purchase ratio with respect to the salesroom A, and the simultaneous-purchase salesroom Q has the second highest simultaneous-purchase ratio with respect to the salesroom A.

In the evaluation data 230 according to the present embodiment, the data described above is associated to each salesroom.

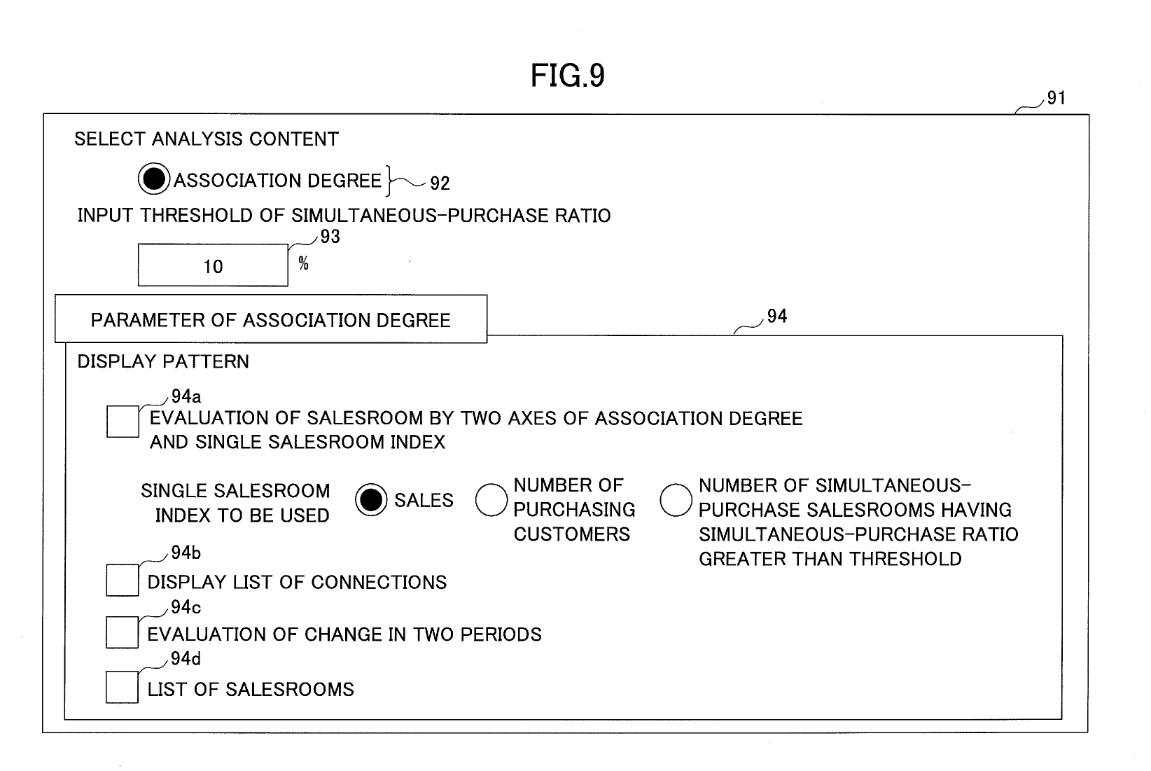

Next, with reference to FIG. 9, a description is given of an input screen generated by the screen generation unit 253 according to the present embodiment. FIG. 9 illustrates an example of an input screen according to the first embodiment.

In an input screen 91 according to the present embodiment, a selection field 92 for selecting the analysis content for each salesroom, a threshold entry field 93 for inputting a threshold of the simultaneous-purchase ratio, and a pattern selection field 94 for selecting a display pattern of the evaluation data 230, are displayed.

The analysis contents according to the present embodiment uses the association degree, and therefore the association degree is selected in the selection field 92. The threshold of the simultaneous-purchase ratio is the threshold used when determining the simultaneous-purchase salesroom to be displayed. In the present embodiment, 10 is input in the threshold entry field 93, and the threshold of the simultaneous-purchase ratio is 10%. In this case, in the present embodiment, a simultaneous-purchase salesroom having a simultaneous-purchase ratio of less than 10% is not displayed.

In the pattern selection field 94 according to the present embodiment, a list of display patterns of information relevant to the evaluation of each salesroom using association degrees is displayed, as options. In the list of display patterns displayed in the pattern selection field 94, an option 94a, an option 94b, and an option 94c are included. Furthermore, in the pattern selection field 94 according to the present embodiment, for example, an option 94d for displaying details of a salesroom included in the evaluation database 230 may be displayed, in addition to the above options.

The option 94a is an option for selecting a pattern for displaying the evaluation of each salesroom according to two index values including, for example, the association degree. In the present embodiment, an index value other than the association degree may be selected. The option 94b is an option for selecting a pattern for displaying the connection between salesrooms based on the association degree and the simultaneous-purchase ratio. The option 94c is an option for selecting a pattern for displaying changes in the association degree and the sales of predetermined two periods of each salesroom.

Note that although not illustrated in FIG. 9, in the present embodiment, for example, a field for selecting the analysis range may be displayed in the input screen. For example, assuming that a department store is one store, and the whole store is the analysis range, the evaluation data 230 of all of the salesrooms in the department store is used for generating the screen described below. Furthermore, for example, when one floor of the department store is selected as the analysis range, the evaluation data 230 of the salesrooms in the corresponding floor is used to generate the screen described below. The analysis range may be a range other than a floor, and may be an arbitrary range that has been selected. Furthermore, for example, the analysis range may be selected for each category of salesrooms in the evaluation data 230.

The screen generation unit 253 according to the present embodiment generates a screen of the selected display pattern, when a display pattern is selected in the pattern selection field 94 of the input screen 91.

In the following, a description is given of cases where each of the option 94a, the option 94b, and the option 94c are selected.

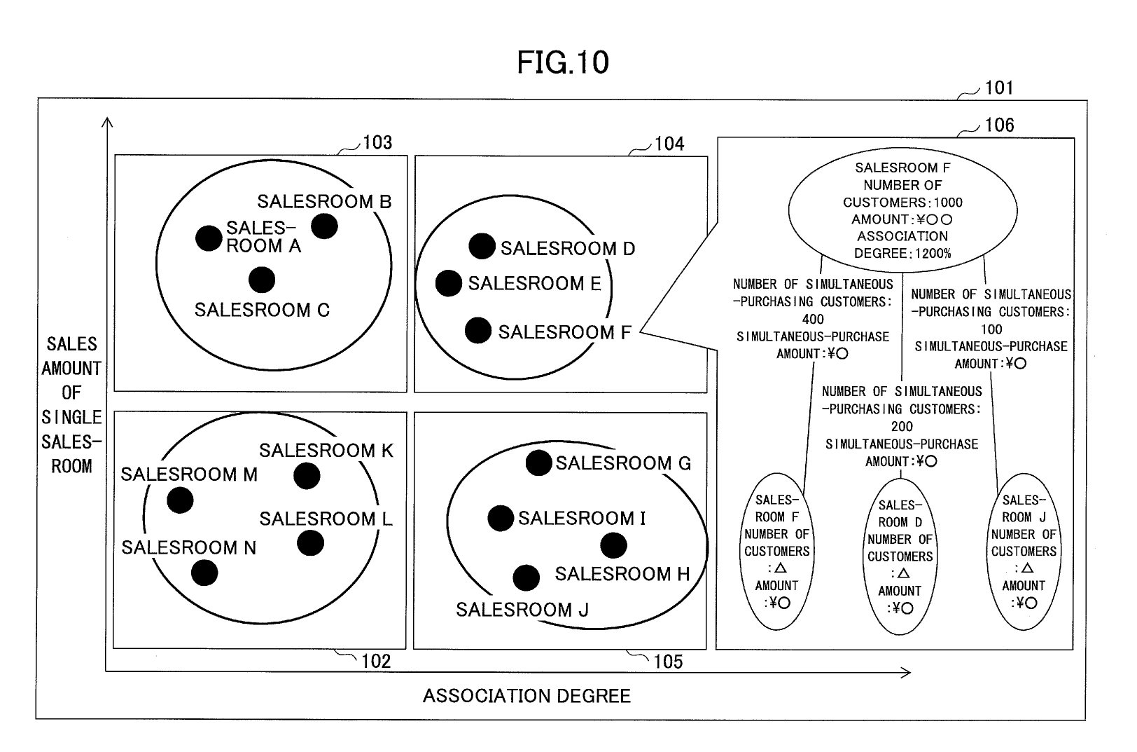

First, a description is given of a case where the option 94a is selected, according to the present embodiment. FIG. 10 is a first diagram for describing the display of evaluations of each salesroom according to a plurality of index values including an association degree.

FIG. 10 illustrates an example of a screen 101 generated by the screen generation unit 253 in a case where the option 94a is selected in the pattern selection field 94 of the input screen 91, and the sales amount of a single salesroom is selected as the index value other than the association degree.

In the screen 101, the evaluations of the salesrooms are displayed, by using a vertical axis expressing the sales amount of each single salesroom, and a horizontal axis expressing the association degree. In the screen 101, the salesrooms are displayed such that a salesroom having a sales amount and an association degree which are both low belongs to a group 102, a salesroom having a high sales amount and a low association degree belongs to a group 103, a salesroom having a sales amount and an association degree which are both high belongs to a group 104, and a salesroom having a low sales amount and a high association degree belongs to a group 105.

A salesroom included in the group 102 has a sales amount and an association degree which are both low, and therefore it is known that the impact will be low even if such a salesroom leaves the store. A salesroom included in the group 103 has a high sales amount and a low association degree, and therefore it is known that such a salesroom has a low effect in sending customers to other salesrooms.

A salesroom included in the group 104 has a sales amount and an association degree which are both high, and therefore it is known that such a salesroom is a major salesroom both in terms of the sales amount and the effect in sending customers to other salesrooms. A salesroom included in the group 105 has a low sales amount but a high association degree, and therefore it is known that such a salesroom has a high effect in sending customers to other salesrooms.

In the present embodiment, by evaluating each salesroom by two index values including the association degree as described above, it is possible to recognize the relationships between the salesrooms.

For example, as to a salesroom included in the group 103, by increasing the association degree, the degree of contribution to the store is further increased.

Furthermore, for example, when considering a salesroom to be a candidate for being eliminated from the store, both a salesroom in the group 102 and a salesroom in the group 103 have a low sales amount per single salesroom. However, a salesroom included in the group 105 has a high effect in sending customers to other salesrooms, and therefore it is known that if such a salesroom is eliminated from the store, there will be a loss in the sales amount that is greater than the sales amount per single salesroom. Therefore, it is known that a candidate for being eliminated from the store is a salesroom included in the group 102.

Furthermore, for example, the screen generation unit 253 according to the present embodiment may include a detail information field 106 of a salesroom F in the screen 101, when the option 94d for displaying detail information of the salesroom F is selected in the input screen 91. In the detail information field 106 of the salesroom F, for example, the association degree, the number of purchasing customers, the simultaneous-purchase salesroom, and the number of simultaneous-purchasing customers of each simultaneous-purchase salesroom may be displayed, with respect to the salesroom F. Furthermore, the detail information field 106 may include the sales amount, and the simultaneous-purchase amount of each simultaneous-purchase salesroom, with respect to the salesroom F. The simultaneous-purchase amount is the total sales amount of articles that have been simultaneous-purchased in the simultaneous-purchase salesroom together with the articles of the salesroom F.

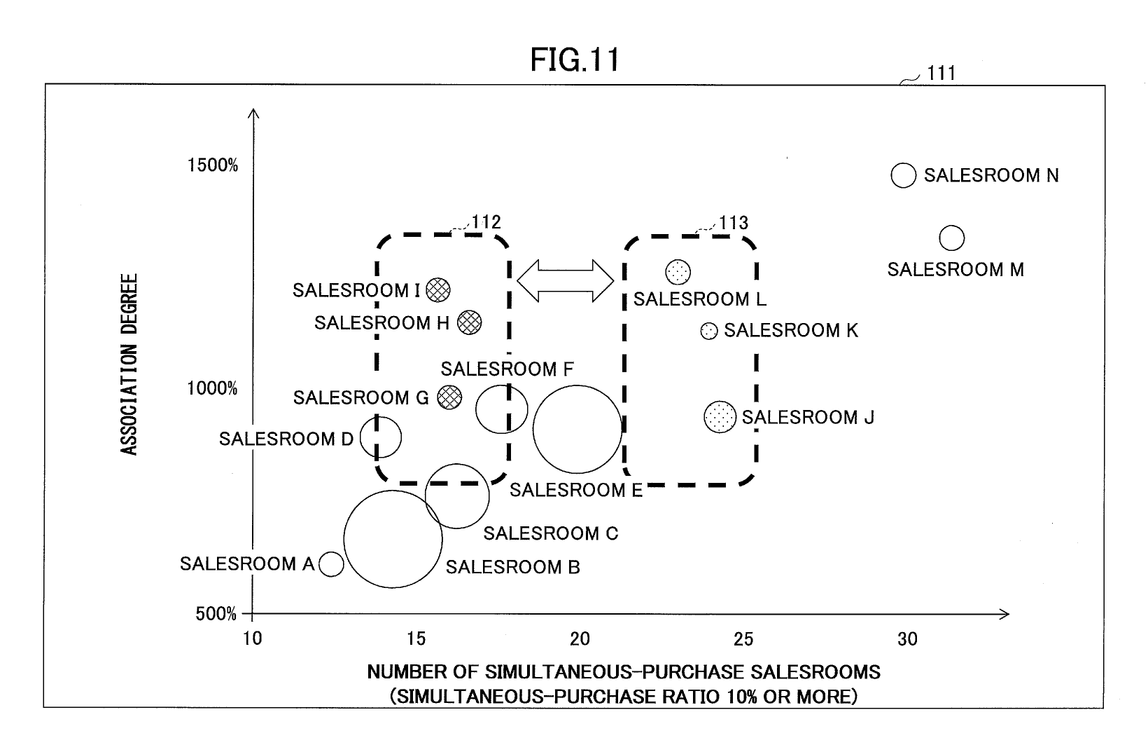

FIG. 11 is a second diagram for describing the display of evaluations of each salesroom according to a plurality of index values including an association degree. FIG. 11 illustrates an example of a screen 111 generated by the screen generation unit 253 in a case where the option 94a is selected in the pattern selection field 94 of the input screen 91, and the number of simultaneous-purchase salesrooms having a simultaneous-purchase ratio that is greater than or equal to a threshold, is selected as an index value other than the association degree.

In the screen 111 illustrated in FIG. 11, the vertical axis expresses the association degree, the horizontal axis expresses the number of simultaneous-purchase salesrooms having a simultaneous-purchase ratio of greater than or equal to 10%, and the sizes of the circles express the number of purchasing customers of each salesroom. That is to say, in the screen 111, the larger the circle of a salesroom, the greater the number of purchasing customers, and the smaller the circle of a salesroom, the less the number of purchasing customers.

Furthermore, in the screen 111, a comparison is made between salesrooms having approximately the same association degree but having a different number of simultaneous-purchasing customers. A group 112 and a group 113 in the screen 111 include salesrooms having an association degree of 750% through 1250%.

The number of simultaneous-purchase salesrooms (having a simultaneous-purchase ratio of greater than or equal to 10%) of a salesroom included in the group 112, is 12 through 17. The number of simultaneous-purchase salesrooms (having a simultaneous-purchase ratio of greater than or equal to 10%) of a salesroom included in the group 113, is 22 through 25. That is to say, salesrooms included in the group 113 have a higher number of simultaneous-purchase salesrooms at which an article is simultaneous-purchased by a high probability.

In the present embodiment, when a simultaneous-purchase salesroom has a high simultaneous-purchase ratio with respect to a particular salesroom, it is considered that there is a strong connection in the relationship between the particular salesroom and the simultaneous-purchase salesroom. In this case, in the screen 111 of FIG. 11, the salesrooms included in the group 113 have more simultaneous-purchase salesrooms with strong connections than the salesrooms included in the group 112.

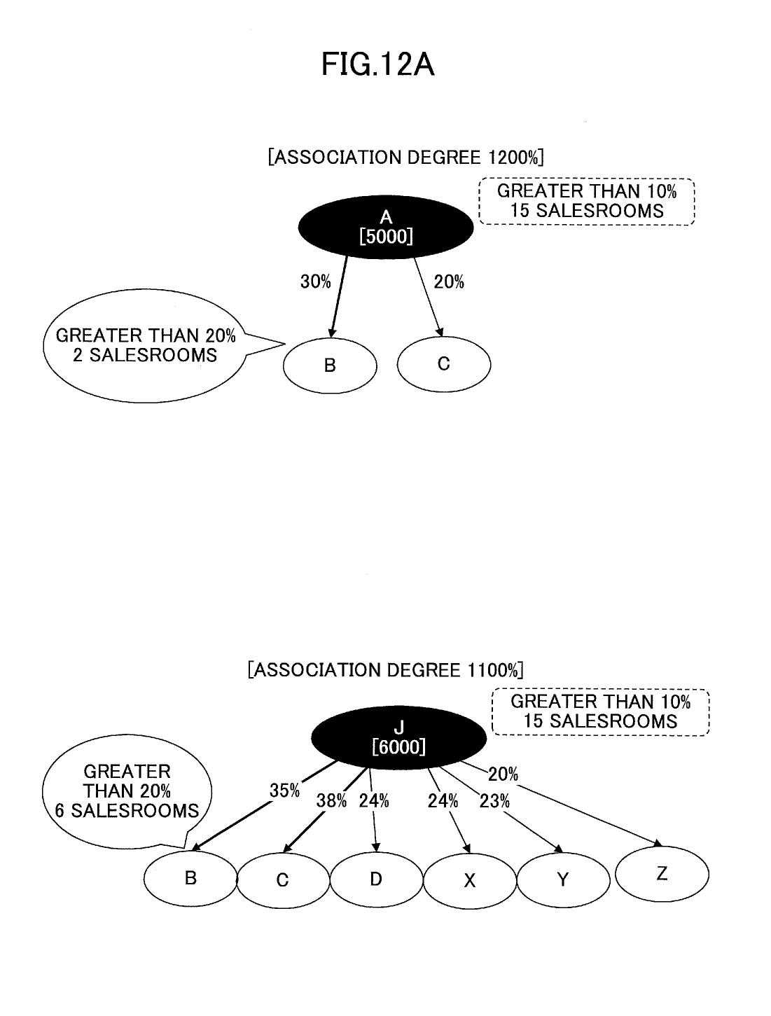

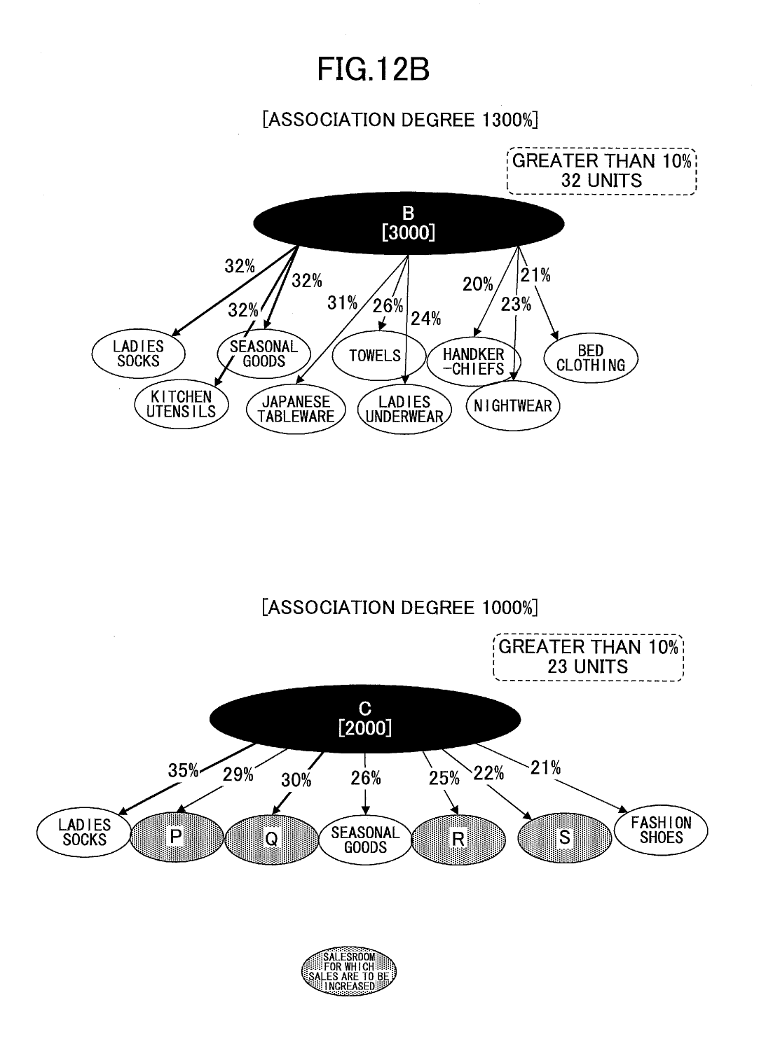

Next, a description is given of a case where the option 94b is selected in the pattern selection field 94 of the input screen 91. FIGS. 12A and 12B are for describing the connection between salesrooms based on the association degree and the simultaneous-purchase ratio. FIG. 12A is for describing the strength of the connection between salesrooms, and FIG. 12B is for describing the interpretation of the strength of the connection.

For example, a salesroom A having an association degree of 1200%, and a salesroom J having an association degree of 1100% illustrated in FIG. 12A, are considered. As the simultaneous-purchase salesrooms having a simultaneous-purchase ratio of greater than or equal to 20% with respect to the salesroom A, there are only two salesrooms, i.e., salesrooms B and C. Furthermore, the number of simultaneous-purchase salesrooms having a simultaneous-purchase ratio of greater than or equal to 10% with respect to the salesroom A, is 15.

Meanwhile, the number of simultaneous-purchase salesrooms having a simultaneous-purchase ratio of greater than or equal to 20% with respect to the salesroom J, is 6, and the number of simultaneous-purchase salesrooms having a simultaneous-purchase ratio of greater than or equal to 10% with respect to the salesroom J, is 15. Therefore, comparing the salesroom A and the salesroom J, the salesroom J having a larger number of simultaneous-purchase salesrooms with a high simultaneous-purchase ratio, has a larger number of strong connections than the salesroom A.

In the present embodiment, by displaying the strength of the connection between salesrooms as results of the evaluation, it is possible for the user to recognize the tendency of each salesroom.

For example, a salesroom B having an association degree of 1300%, and a salesroom C having an association degree of 1000% illustrated in FIG. 12B, are considered.

As to the salesroom B, the number of simultaneous-purchase salesrooms having a simultaneous-purchase ratio of greater than or equal to 10%, is 32; however, there are no simultaneous-purchase salesrooms having a simultaneous-purchase ratio of greater than or equal to 20%. Thus, the salesroom B is connected with many salesrooms; however, there are no simultaneous-purchase salesrooms with which the salesroom B has a strong connection. That is to say, it is interpreted that the salesroom B is connected with a large indefinite number of salesrooms without any characteristic tendency.

As to the salesroom C, the number of simultaneous-purchase salesrooms having a simultaneous-purchase ratio of greater than or equal to 10%, is 23. In the present embodiment, for example, when a list of simultaneous-purchase salesrooms of the salesroom C includes a salesroom for which the sales are desired to increase, it is interpreted that it is possible to increase the sales of the corresponding salesroom by strengthening the connection with the salesroom C.

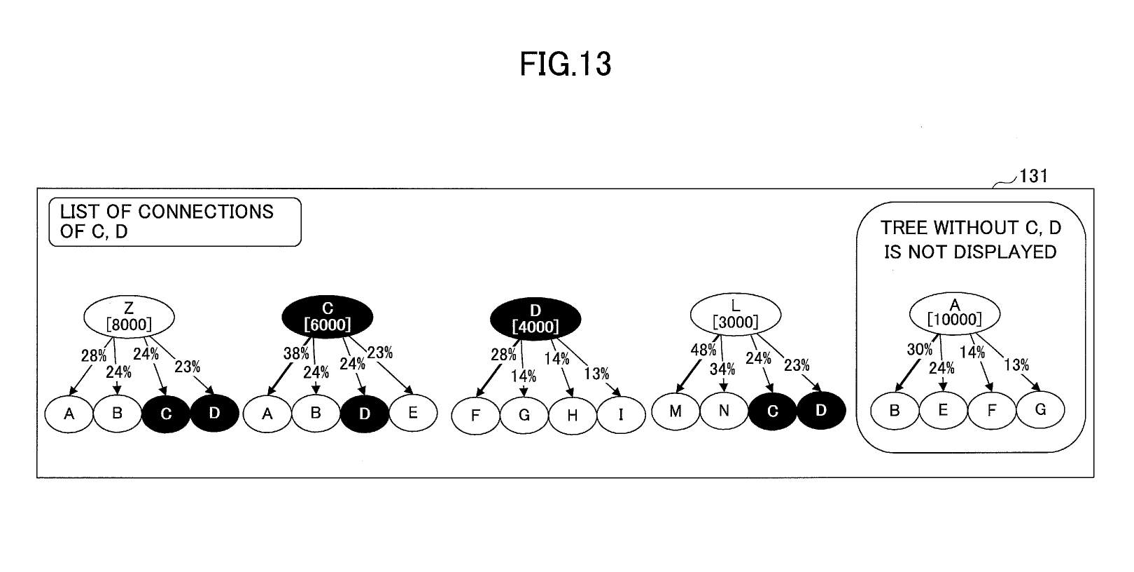

FIG. 13 is for describing a display of a list of connections between salesrooms based on the association degree and the simultaneous-purchase ratio.

FIG. 13 illustrates an example of a screen 131 generated by the screen generation unit 253 in a case where the option 94b is selected in the pattern selection field 94 of the input screen 91, and 10% is input in the threshold entry field 93 of the simultaneous-purchase ratio.

The screen 131 indicates a list of connections between the salesroom C and the salesroom D, and other salesrooms. In the present embodiment, for example, when the option 94b in the input screen 91 is selected, an input field for inputting a salesroom name for which a list of connections is to be displayed, may be displayed. The screen 131 is an example of a case where the salesrooms C and D are input as the salesroom names for which a list of connections is to be displayed.

In the screen 131, the salesroom C is a simultaneous-purchase salesroom of the salesroom Z and the salesroom L, and the salesroom D is a simultaneous-purchase salesroom of the salesroom Z, the salesroom C, and the salesroom L.

In the present embodiment, as illustrated in FIG. 13, it is possible to display the connection between a particular salesroom and another salesroom, and the strength of the connection. Thus, in the present embodiment, for example, it is possible to evaluate each salesroom, while recognizing how a salesroom, for which the sales is desired to be increased in the future, is related with other salesrooms.

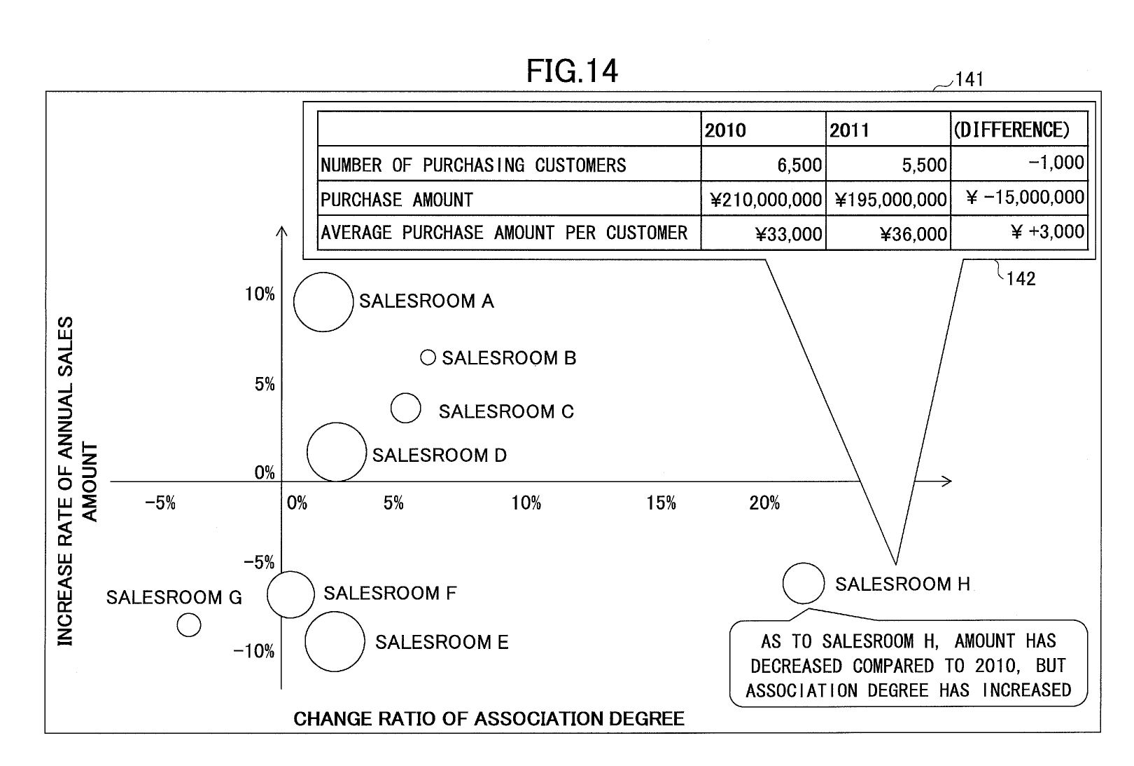

Next, with reference to FIG. 14, a description is given of a case where the option 94c in the input screen 91 is selected. FIG. 14 is for describing the display of changes in the association degree and the sales during predetermined two periods of each salesroom.

FIG. 14 illustrates an example of a screen 141 generated by the screen generation unit 253 in a case where the option 94c is selected in the pattern selection field 94 of the input screen 91, and the two periods are the year 2010 and the year 2011.

In the screen 141, the vertical axis expresses the increase rate of the annual sales amount of 2011 with respect to the annual sales amount of 2010, and the horizontal axis expresses the change ratio of the association degree of 2011 with respect to the association degree of 2010. Note that the association degree of 2010 and the association degree of 2011 may be an average value of association degrees throughout the year, or the association degree calculated at the end of the year. Furthermore, the sizes of the circles in the screen 141 indicate the number of purchasing customers of each salesroom.

In the screen 141, for example, the change ratio of the association degree of the salesroom A is less than 5%; however, the increase rate of annual sales is approximately 10%. In this case, it is considered that the annual sales of the salesroom A has simply increased.

For example, when a particular salesroom is selected when the screen 141 is displayed, the screen generation unit 253 according to the present embodiment may display a detail information field of the selected salesroom, on the screen 141. In the example of FIG. 14, the salesroom H is selected and a detail information field 142 of the salesroom H is displayed.

In the detail information field 142 of the salesroom H, the number of purchasing customers of each year, the annual purchase amount, the average purchase amount per customer, and the difference between years, with respect to the salesroom H, are displayed. According to this detail information field, the number of customers and the annual purchase amount have decreased, but the average purchase amount per customer has increased.

Furthermore, as to the salesroom H, the annual sales amount has decreased compared to 2010, but the association degree has increased. Therefore, the decrease in the annual sales amount of the salesroom H is interpreted as being caused by the decrease in the number of purchasing customers, and the increase in the association degree and the average purchase amount per customer is interpreted as being caused by the increase in the number of regular customers who purchase articles of the salesroom H by a high probability.

Therefore, as to the salesroom H, it may be interpreted that “although the annual sales amount has decreased, future increases in sales may be expected”, and therefore it is possible to prevent the salesroom H from being undervalued due to the decrease in the annual sales amount.

Next, a description is given of a process by the simulation execution unit 255 according to the present embodiment. In the present embodiment, in addition to the evaluation of each salesroom, for example, the evaluation of a particular salesroom when an article of a particular manufacturer (brand) is introduced in the particular salesroom, may be obtained by simulation.

Specifically, the simulation execution unit 255 according to the present embodiment performs a simulation for, for example, a case where a brand a has been introduced in the salesroom Y, based on the evaluation data 230 of the salesroom X in which the brand a has been introduced, and calculates the introduction result. The simulation execution unit 255 according to the present embodiment performs simulations of a case where the conditions are the same for the salesroom X in which the brand a has been introduced and the salesroom Y which is the simulation target in which the brand a is scheduled to be introduced, and a case where the conditions are different for the salesroom X and the salesroom Y in the above instances.

In the present embodiment, conditions include the scale of the salesroom (the number of purchasing customers in the whole salesroom, the sales, etc.), and brands handled other than the brand a. That is to say, the salesroom X and the salesroom Y have the same sales scale and handle the same brands other than brand a. Furthermore, introducing brand a in the salesroom Y means to handle products of the brand a in the salesroom Y.

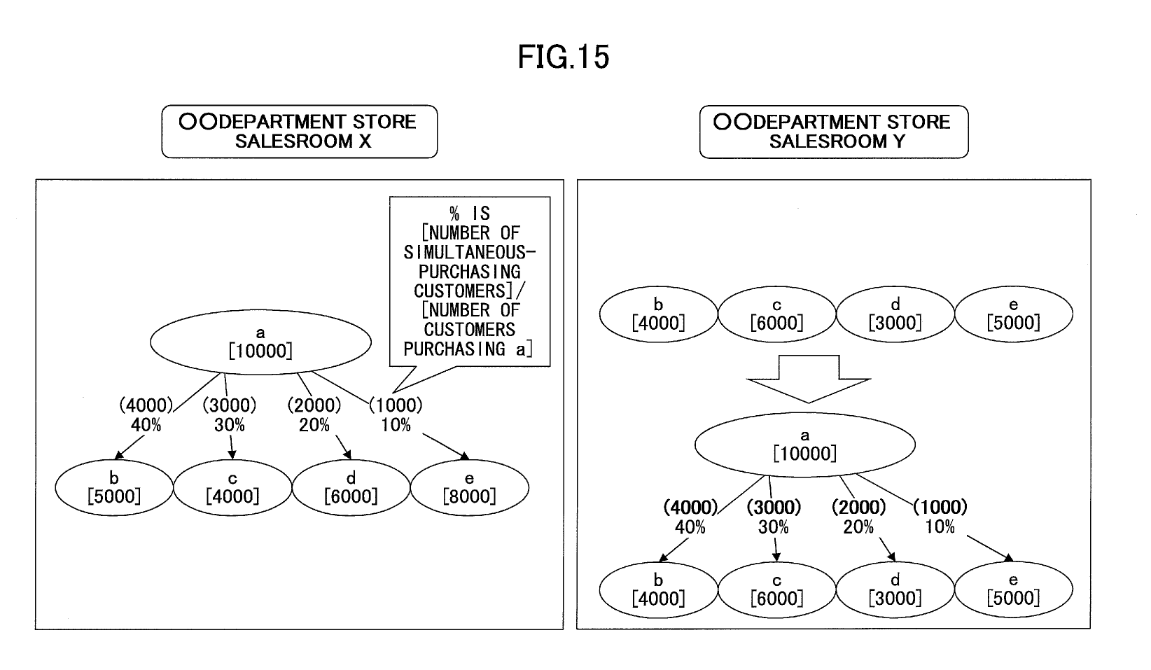

First, with reference to FIG. 15, a description is given of a simulation in a case where the conditions are the same for the salesroom X and the salesroom Y.

FIG. 15 is a first diagram for describing a simulation performed by the simulation execution unit 255. The simulation execution unit 255 according to the present embodiment calculates the introduction effect in a case where a brand a is introduced in a salesroom Y in which the brand a has not been introduced, based on the association degree of the salesroom X in which the brand a has been introduced.

Note that when executing the process described below by the simulation execution unit 255, the purchase history database 210 includes purchase history data of the brand for each customer. Furthermore, the evaluation data 230 includes evaluation data in which the respective items illustrated in FIG. 8 have been analyzed for each brand.

First, the simulation execution unit 255 according to the present embodiment calculates the association degree of the brand a in the salesroom X in which the brand a has been introduced. The association degree of the brand a means the degree to which a customer, who has purchased an article of the brand a which is an evaluation target brand in the salesroom X, purchases an article of another brand.

The number of purchasing customers of the brand a in the salesroom X is 10000, and the numbers of simultaneous-purchasing customers of brands b, c, d, and e are 4000, 3000, 2000, and 1000, respectively. Accordingly, the association degree of the brand a in the salesroom X is 100%.

The salesroom Y of FIG. 15 has the same conditions as the salesroom X, except that the brand a has not been introduced in the salesroom Y. Accordingly, when the brand a is introduced in the salesroom Y, it is estimated that the association degree of the brand a becomes the same as that of the salesroom X.

Thus, as the introduction effect of introducing the brand a in the salesroom Y, the simulation execution unit 255 may calculate the sales of the brand a and the sales of simultaneously purchasing brands b, c, d, e with brand a, as the sales of the salesroom Y.

More specifically, the numbers of purchasing customers of brands b, c, d, e in the salesroom Y are 4000, 6000, 3000, and 5000, respectively. Furthermore, the numbers of simultaneous-purchasing customers of brands b, c, d, e with respect to the brand in the salesroom X are 4000, 3000, 2000, and 1000, respectively. Therefore, when the brand a is introduced in the salesroom Y, it is estimated that among the 4000 purchasing customers of the brand b, 4000 customers will purchase articles of the brand a, and among the 6000 purchasing customers of the brand c, 3000 customers will purchase articles of the brand a. Similarly, it is estimated that among the 3000 purchasing customers of the brand d, 2000 customers will purchase articles of the brand a, and among the 5000 purchasing customers of the brand e, 1000 customers will purchase articles of the brand a.

Thus, the simulation execution unit 255 calculates the purchase amount of simultaneous-purchasing of the brands b, c, d, e, in addition to the purchase amount of the brand a.

Note that the simulation execution unit 255 according to the present embodiment sets the maximum number of simultaneous-purchasing customers of the brands b, c, d, e when the brand a is introduced in the salesroom Y, as the number of purchasing customers of each of the brands b, c, d, e in the salesroom Y.

Specifically, for example, when the number of purchasing customers of the brand b in the salesroom Y is 2000, and the number of simultaneous-purchasing customers of the brand b when the brand a is introduced in the salesroom Y is 3000, the simulation execution unit 255 calculates the introduction effect by setting the number of simultaneous-purchasing customers of brand b as 2000. Accordingly, it is possible to prevent a contradiction from occurring, where the number of simultaneous-purchasing customers of the brand b when the brand a is introduced exceeds the number of purchasing customers of the brand b.

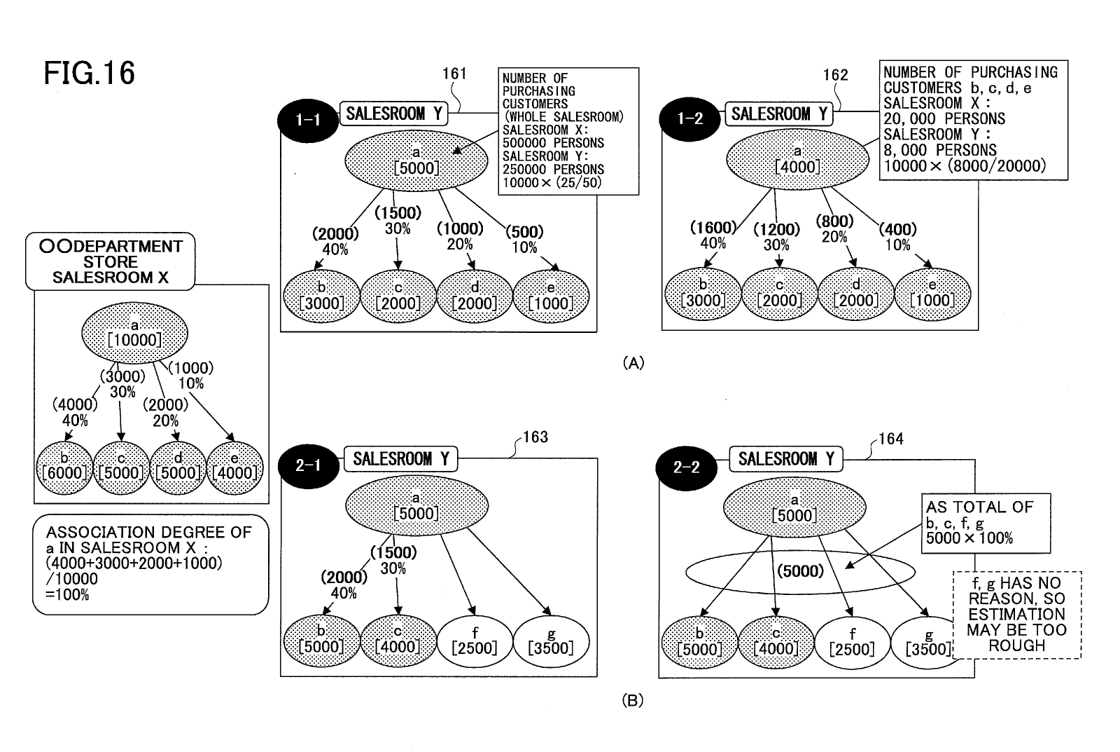

Next, with reference to FIG. 16, a description is given of a simulation in a case where the conditions of the salesroom X and the salesroom Y are different.

FIG. 16 is a second diagram for describing a simulation performed by the simulation execution unit 255.

In the example of FIG. 16, in a salesroom X where the brand a has been introduced, the number of purchasing customers of the brand a is 10000, and the numbers of simultaneous-purchasing customers of the brands b, c, d, e are 4000, 3000, 2000, 1000, respectively. Thus, the association degree of the brand a in the salesroom X is 100%.

FIG. 16 (A) indicates the simulation result in a case where the scale of the salesroom Y is different from the scale of the salesroom X. When the scale of the salesroom Y is different from the scale of the salesroom X, it is not possible to directly use the number of purchasing customers of the brand a in the salesroom X in the simulation, when calculating the introduction effect of the brand a.

Thus, the simulation execution unit 255 executes the simulation for calculating the introduction effect, by the following two methods. Note that in the simulation described with reference to FIG. 16, the number of purchasing customers of the brand a when the brand a is introduced in the salesroom Y, is calculated as the introduction effect of the brand a.

The first method is to estimate the number of purchasing customers of the brand a, from the ratio of the numbers of purchasing customers in the whole salesroom of the salesroom X and the salesroom Y. In the following description, this is referred to as the first method 1-1. The second method is to estimate the number of purchasing customers of the brand a, from the ratio of the total number of purchasing customers of the brands b, c, d, e of each of the salesroom X and the salesroom Y. In the following description, this is referred to as the second method 1-2.

The screen 161 is a screen displayed on the terminal device 300 as a simulation result, when simulation by the method 1-1 is selected, in the input screen when executing the simulation described below.

In the example of the screen 161, the number of purchasing customers of the whole salesroom X is 500000, and the number of purchasing customers of the whole salesroom Y is 250000. In this case, the ratio of the numbers of purchasing customers of the whole salesroom of the salesroom X and the salesroom Y is 250000/500000=½.

Thus, the simulation execution unit 255 calculates the product of the number of purchasing customers of the brand a in the salesroom X and ½, as the number of purchasing customers of the brand a in the salesroom Y. As a result, the number of purchasing customers of the brand a in the salesroom Y is 5000.

Furthermore, the simulation execution unit 255 calculates the product of the number of simultaneous-purchasing customers of the brands b, c, d, e in the salesroom X, and the ratio of the numbers of purchasing customers in the whole salesroom of the salesroom X and the salesroom Y, to calculate the number of simultaneous-purchasing customers of the brands b, c, d, e in the salesroom Y. Specifically, the numbers of simultaneous-purchasing customers of the brands b, c, d, e at point X are 4000, 3000, 2000, and 1000, respectively. Therefore, the numbers of simultaneous-purchasing customers of the brands b, c, d, e in the salesroom Y are 2000, 1500, 1000, and 500, respectively.

A screen 162 is a screen that is displayed on the terminal device 300 as a simulation result, when simulation by the method 1-2 is selected, in the input screen when executing the simulation described below.

In the example of the screen 162, the numbers of purchasing customers of the brands b, c, d, e in the salesroom X are 6000, 5000, 5000, and 4000, respectively, Thus, the total number of purchasing customers of the brands b, c, d, e in the salesroom X is 20000.

Furthermore, the numbers of purchasing customers of the brands b, c, d, e in the salesroom Y are 3000, 2000, 2000, and 1000, respectively, Thus, the total number of purchasing customers of the brands b, c, d, e in the salesroom X is 8000. In this case, the ratio of the total numbers of purchasing customers of the brands b, c, d, e of the salesroom X and the salesroom Y is 8000/20000=⅖.

Thus, the simulation execution unit 255 calculates the product of the number of purchasing customers of the brand a in the salesroom X and ⅖, as the number of purchasing customers of the brand a in the salesroom Y. As a result, the number of purchasing customers of the brand a in the salesroom Y is 4000. Furthermore, the simulation execution unit 255 calculates the product of the number of simultaneous-purchasing customers of the brands b, c, d, e in the salesroom X, and the ratio of the total numbers of purchasing customers of the brands b, c, d, e of the salesroom X and the salesroom Y, to calculate the number of simultaneous-purchasing customers of the brands b, c, d, e in the salesroom Y.

FIG. 16 (B) indicates the simulation result in a case where the scale of the salesroom Y is different from the scale of the salesroom X, and the brands introduced in the salesroom X are different from the brands introduced in the salesroom Y.

In this case, the simulation execution unit 255 executes the simulation for calculating the introduction effect, by the following two methods.

The first method is to estimate the number of purchasing customers of the brand a, based on the scales of the salesroom X and the salesroom Y, and to estimate the number of simultaneous-purchasing customers of the brand a based on a brand commonly introduced in the salesroom X and the salesroom Y. In the following description, this is referred to as the first method 2-1.

The second method is to estimate the number of purchasing customers of the brand a in the salesroom Y, from the association degree of the brand a in the salesroom X. In the following description, this is referred to as the second method 2-2.

A screen 163 is a screen that is displayed on the terminal device 300 as a simulation result, when simulation by the method 2-1 is selected, in the input screen when executing the simulation described below.

In the example of the screen 163, brands b, c, f, g are introduced in the salesroom Y, and the brands common to the salesroom X and the salesroom Y are the brands b, c.

Thus, the simulation execution unit 255 calculates the number of purchasing customers of the brand a, based on the brands b, c. In this case, the method of calculating the number of purchasing customers is the same as either one of the method 1-1 or the method 1-2 described above.

The ratio of the numbers of purchasing customers in the whole salesroom of the salesroom X and the salesroom Y is ½. Thus, the simulation execution unit 255 calculates the product of the number of purchasing customers of the brand a in the salesroom X and ½, as the number of purchasing customers of the brand a in the salesroom Y. Note that the number of purchasing customers of the brand a in the salesroom Y may be calculated by the method 1-2 described above.

Furthermore, a number of customers obtained by multiplying the number of simultaneous-purchasing customers of the brands b, c in the salesroom X by ½, is set as the number of simultaneous-purchasing customers of the brand a in the salesroom Y.

A screen 164 is a screen that is displayed on the terminal device 300 as a simulation result, when simulation by the method 2-2 is selected, in the input screen when executing the simulation described below.

In the example of the screen 164, the simulation execution unit 255 calculates the number of purchasing customers of the brand a in the salesroom Y, from the ratio of the numbers of purchasing customers in the whole salesroom of the salesroom X and the salesroom Y, and calculates the number of simultaneous-purchasing customers of the brand a in the salesroom Y from the association degree of the brand a in the salesroom X.

In the example of FIG. 16, the association degree of the brand a in the salesroom X is 100%, and the number of purchasing customers of the brand a in the salesroom Y is 5000. Therefore, the total number of simultaneous-purchasing customers of the brand a in the salesroom Y is 5000×1(100%)=5000.

As described above, the simulation execution unit 255 according to the present embodiment may calculate the number of purchasing customers and the number of simultaneous-purchasing customers of the brand a in the salesroom Y, when the brand a is introduced in the salesroom Y, based on the evaluation data 230 of the salesroom X in which the brand a has been introduced.

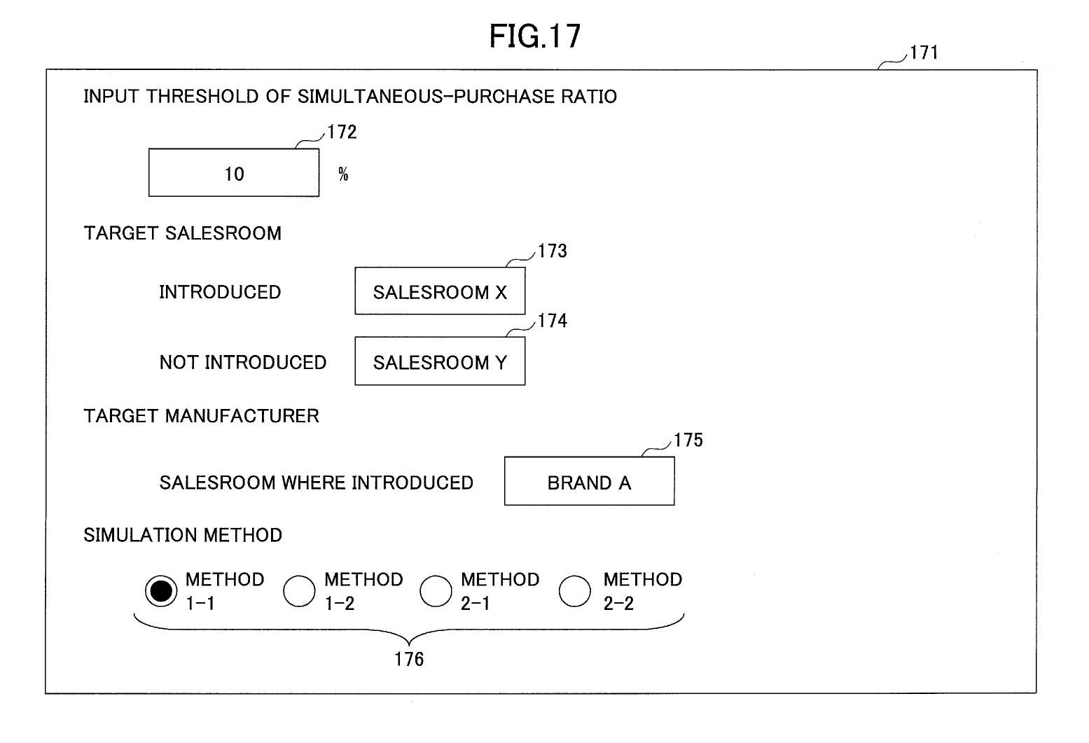

FIG. 17 illustrates another example of an input screen according to the first embodiment. An input screen 171 illustrated in FIG. 17 is an example of a screen that is generated by the screen generation unit 253 and sent to the terminal device 300 by the screen sending unit 254 when, for example, execution of a simulation is instructed at the terminal device 300.

In the input screen 171, a threshold entry field 172 for inputting a threshold of the simultaneous-purchase ratio, evaluation target entry fields 173, 174 for inputting the salesrooms that are evaluation targets, a brand name entry field 175 for inputting the brand name that is to be the evaluation target, and a method selection field 176 for selecting the method of simulation, are displayed.

The evaluation target entry field 173 is for inputting the name of the salesroom in which the brand that is the evaluation target has been introduced. The evaluation target entry field 174 is for inputting the name of the salesroom in which the brand that is the evaluation target is not introduced. In the example of FIG. 17, 1-1 is selected as the method of simulation.

In the present embodiment, for example, when a threshold of the simultaneous-purchase ratio has been input in the threshold entry field 172 of the input screen 171, only the brand whose simultaneous-purchase ratio is greater than or equal to the threshold is displayed as a simulation result. Furthermore, the simulation execution unit 255 according to the present embodiment executes the above simulation according to the method selected in the method selection field 176 for selecting the method of simulation, in the input screen 171.

As described above, the evaluation support server 200 according to the present embodiment calculates the association degree, and displays the relationship between salesrooms according to a plurality of index values including the association degree, and is thus capable of enabling a user to appropriately evaluate a salesroom.

### Second Embodiment

A second embodiment of the present invention is described below with reference to drawings. In the second embodiment, only the point of calculating the support degree instead of the association degree is different from the first embodiment. Thus, in the following description of the second embodiment, only the points that are different from those of the first embodiment are described, and elements having the same functional configuration as those of the first embodiment are denoted by the same reference numerals, and descriptions thereof are omitted.

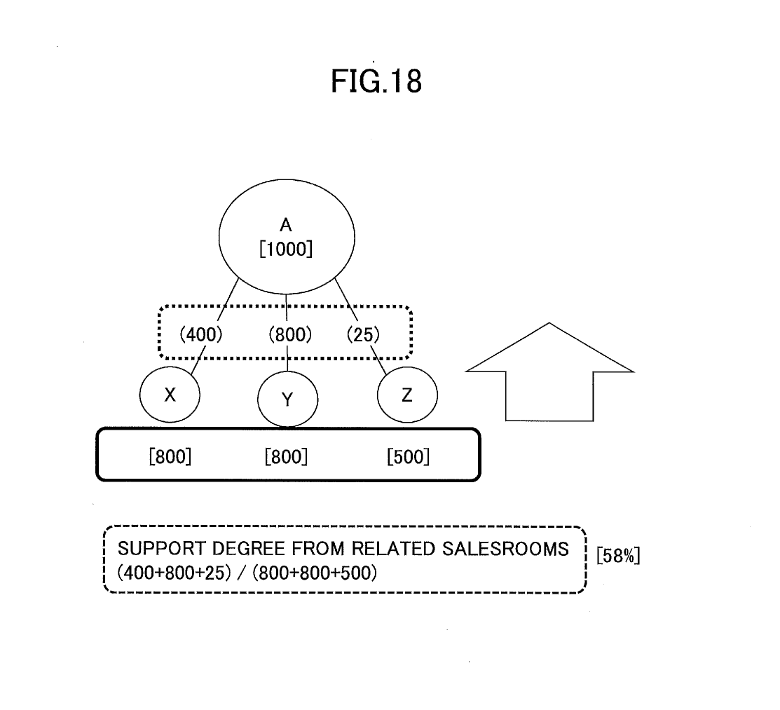

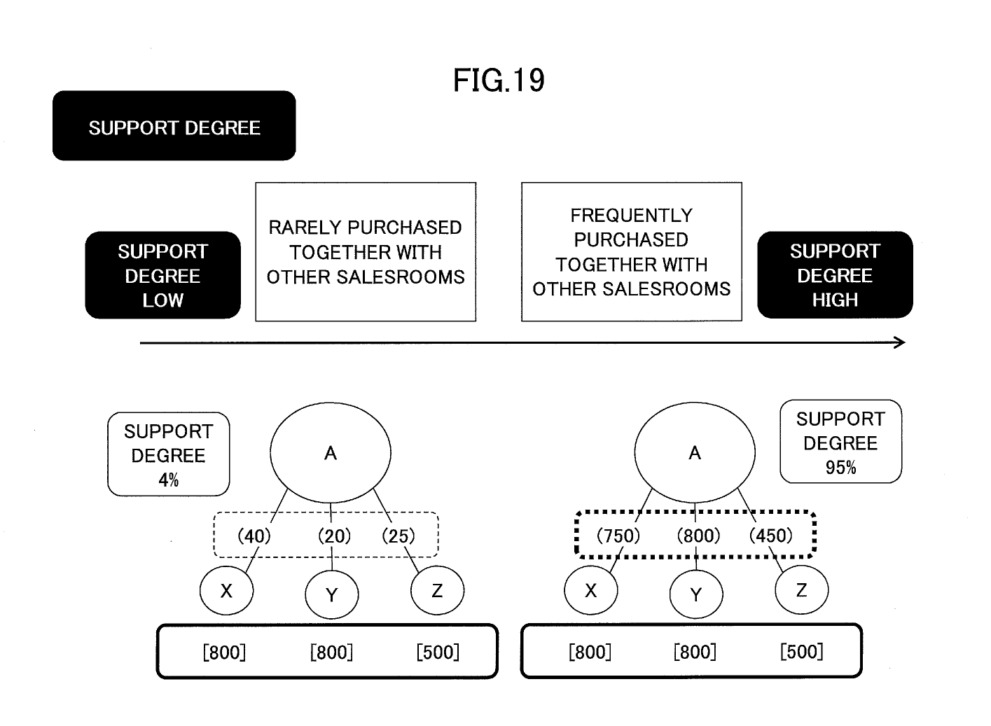

In the following, with reference to FIGS. 18 and 19, a description is given of a support degree according to the present embodiment. FIG. 18 is a first diagram for describing the support degree.

A support degree according to the present embodiment is the degree to which a customer, who has purchased an article at a salesroom other than the evaluation target salesroom, purchases an article at the evaluation target salesroom. Specifically, the support degree according to the present embodiment is calculated by “the total number of customers who have purchased an article of the evaluation target salesroom simultaneously as purchasing an article of another salesroom/the total number of customers who have purchased an article at a salesroom other than the evaluation target salesroom x 100[%]”.

In FIG. 18, a description is given of a case where the evaluation target salesroom is a salesroom A. In the present embodiment, based on the purchase history data of a store in which the salesroom A is open, the number of customers who have purchased an article in a salesroom other than the salesroom A in a predetermined period is acquired. Furthermore, in the present embodiment, based on the purchase history data, the total number of customers who have purchased an article in the salesroom A simultaneously as purchasing an article of another salesroom in a predetermined period is acquired.

In FIG. 18, the numbers of customers who have purchased articles at the salesrooms X, Y, Z other than the salesroom A, are 800, 800, and 500, respectively, and the total number of customers who have purchased articles at the salesrooms X, Y, Z is 800+800+500=2100. Furthermore, the number of customers in the salesroom X who have simultaneous-purchased an article of the salesroom A is 400. Similarly, the number of customers in the salesroom Y who have simultaneous-purchased an article of the salesroom A is 800, and the number of customers in the salesroom Z who have simultaneous-purchased an article of the salesroom A is 25. Thus, the total number of customers who have purchased an article at the evaluation target salesroom simultaneously as purchasing an article of another salesroom is 400+800+25=1225.

Thus, the support degree of the salesroom A is 1225/2100×100=58.333%. In the present embodiment, the support degree is obtained by rounding off the numbers less than a decimal point. Accordingly, the support degree of the salesroom A is 58%.

Note that the support degree of the present embodiment is calculated by using the number of purchasing customers; however, the present invention is not so limited. The support degree may be calculated by using, for example, the sales amount of a certain single salesroom and the amount of simultaneous-purchasing an article in a simultaneous-purchase salesroom of the certain salesroom (simultaneous-purchase amount). Furthermore, the support degree may be calculated by using the sales amount of a certain single salesroom/an average unit indicated by the number of sales customers.

Next, with reference to FIG. 19, a description is given of a method of interpreting the support degree according to the present embodiment. FIG. 19 is a second diagram for describing the support degree.

In FIG. 19, a description is given of a case where the support degree of the salesroom A is 4%, and a case where the support degree of the salesroom A is 95%.

In a case where the support degree of the salesroom A is 4%, the number of customers in the salesroom X who have simultaneous-purchased an article of the salesroom A, the number of customers in the salesroom Y who have simultaneous-purchased an article of the salesroom A, and the number of customers in the salesroom Z who have simultaneous-purchased an article of the salesroom A, are 40, 20, and 25, respectively.

Furthermore, in a case where the support degree of the salesroom A is 95%, the number of customers in the salesroom X who have simultaneous-purchased an article of the salesroom A, the number of customers in the salesroom Y who have simultaneous-purchased an article of the salesroom A, and the number of customers in the salesroom Z who have simultaneous-purchased an article of the salesroom A, are 750, 800, and 450, respectively.

That is to say, when the support degree of the salesroom A is high, it means that a customer who has purchased an article in a salesroom X, Y, Z other than the salesroom A is highly likely to purchase an article in the salesroom A, and that the degree of contribution to the store is high and a good influence is given to the store. For example, when the salesroom A having a high support degree is eliminated from the store, it is considered that the sales of the salesrooms X, Y, Z will decrease.

Furthermore, when the support degree of the salesroom A is low, it means that a customer who has purchased an article in a salesroom X, Y, Z other than the salesroom A is hardly likely to purchase an article in the salesroom A, and that the degree of contribution to the store is low. For example, when the salesroom A having a low support degree is eliminated from the store, it is considered that the sales of the salesroom A alone will decrease from the whole store, but there will be a small impact on the sales of the salesrooms X, Y, Z.

According to the above, the higher the support degree of a salesroom, the higher the effect of sending customers to other salesrooms, and the lower the support degree of a salesroom, the lower the effect of sending customers to other salesrooms.

In the evaluation support system 100 according to the present embodiment, the support degree described above is calculated at the evaluation support server 200, and the terminal device 300 is caused to display a screen relevant to the evaluation of each salesroom according to a plurality of index values including the support degree.

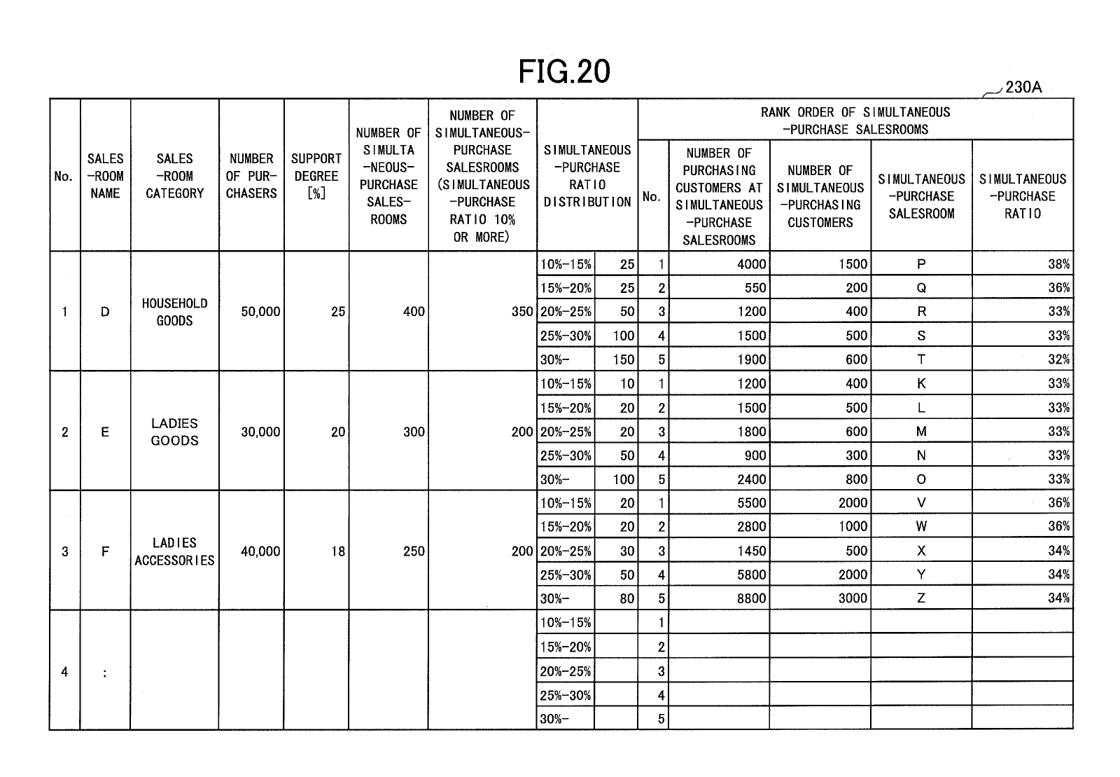

FIG. 20 illustrates an example of evaluation data according to the second embodiment. In evaluation data 230A illustrated in FIG. 20, the support degree is calculated instead of the association degree in the evaluation data 230 of the first embodiment.

In the present embodiment, the terminal device 300 is caused to display a screen relevant to the evaluation of each salesroom corresponding to input, with the use of the evaluation data 230A.

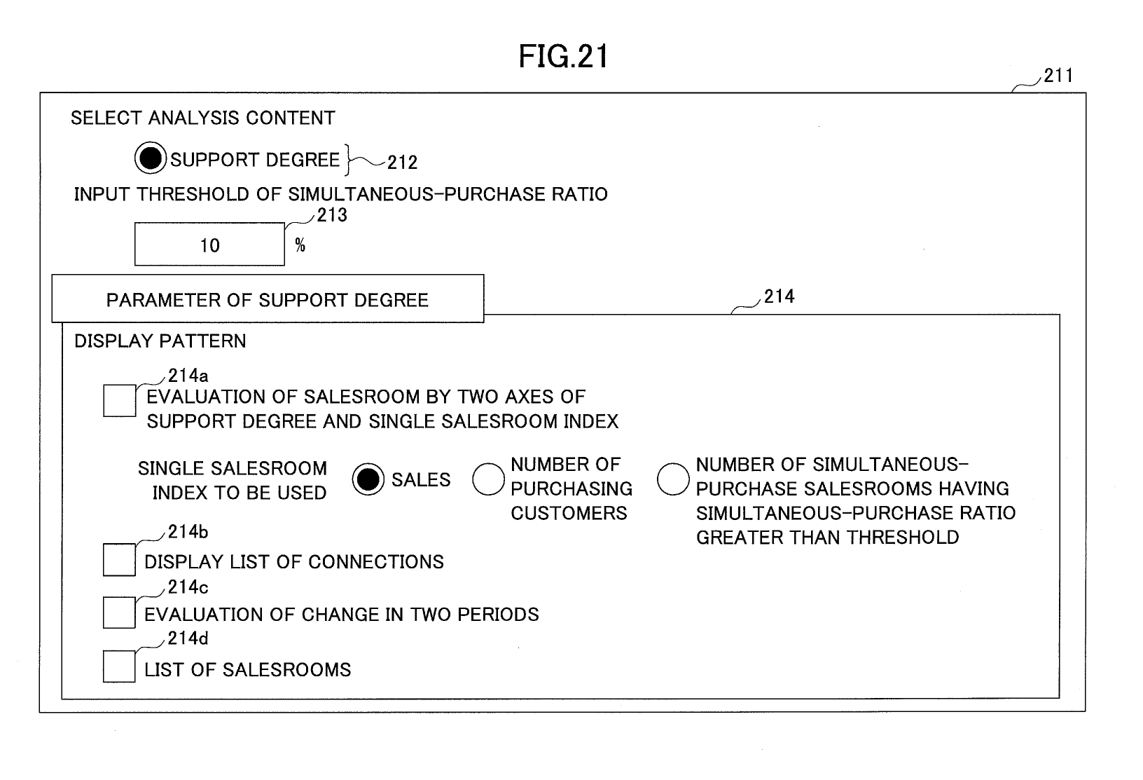

FIG. 21 illustrates an example of an input screen according to the second embodiment.

In an input screen 211 according to the present embodiment, a selection field 212 for selecting the analysis content for each salesroom, a threshold entry field 213 for inputting a threshold of the simultaneous-purchase ratio, and a pattern selection field 214 for selecting a display pattern of the evaluation data 230A, are displayed.

The analysis contents according to the present embodiment uses a support degree, and therefore the support degree is selected in the selection field 212. The threshold of the simultaneous-purchase ratio is used as the threshold when determining the simultaneous-purchase salesroom to be displayed. In the present embodiment, 10 is input in the threshold entry field 213, and the threshold of the simultaneous-purchase ratio is set to be 10%.

In the pattern selection field 214 according to the present embodiment, a list of display patterns of information relevant to the evaluation of each salesroom using support degrees is displayed, as options. In the list of display patterns displayed in the pattern selection field 214, an option 214a, an option 214b, and an option 214c are included. Furthermore, in the pattern selection field 214 according to the present embodiment, for example, an option 214d for displaying details of a salesroom included in the evaluation database 230A may be displayed, in addition to the above options.

The option 214a is an option for selecting a pattern for displaying the evaluation of each salesroom according to a plurality of index values including, for example, the support degree. In the present embodiment, an index value other than the support degree may be selected. The option 214b is an option for selecting a pattern for displaying the connection between salesrooms based on the support degree and the simultaneous-purchase ratio. The option 214c is an option for selecting a pattern for displaying changes in the support degree and the sales of predetermined two periods of each salesroom.

The screen generation unit 253 according to the present embodiment generates a screen of the selected display pattern, when a display pattern is selected in the pattern selection field 214 of the input screen 211.

In the following, a description is given of cases where each of the option 214a, the option 214b, and the option 214c are selected.

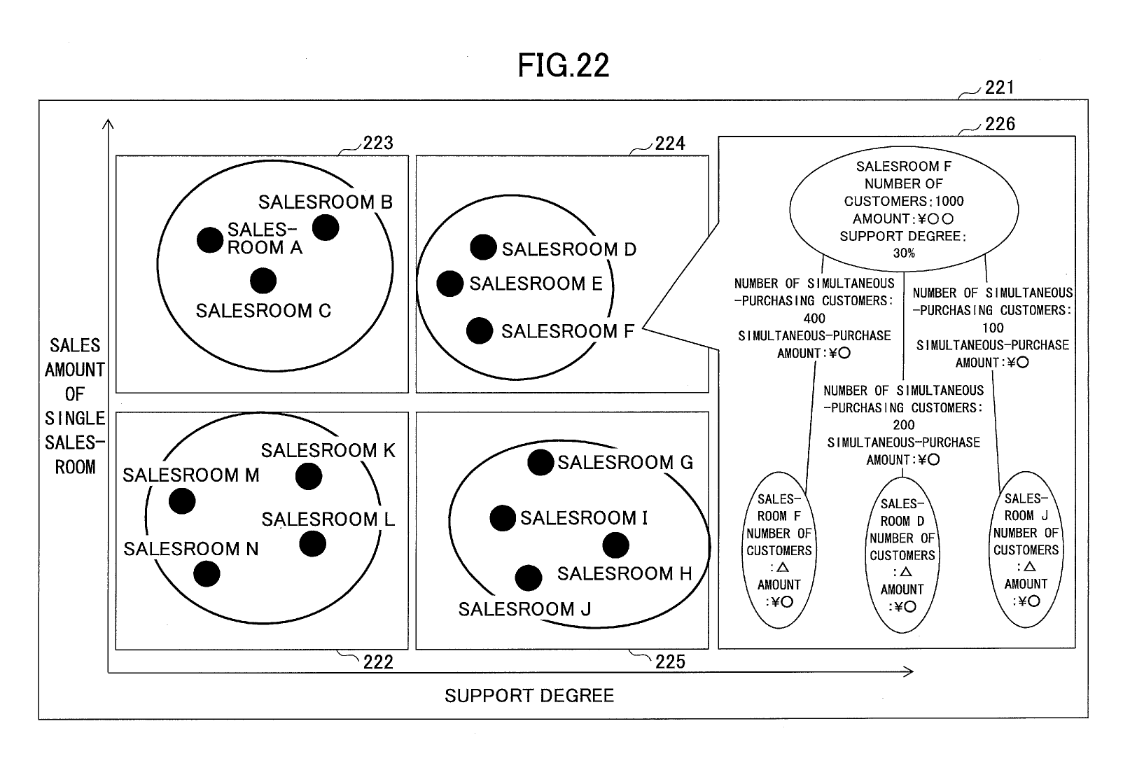

FIG. 22 is a first diagram for describing the display of evaluations of each salesroom according to a plurality of index values including a support degree.

FIG. 22 illustrates an example of a screen 221 generated by the screen generation unit 253 in a case where the option 214a is selected in the pattern selection field 214 of the input screen 211, and the sales amount of a single salesroom is selected as the index value other than the support degree. The screen 221 according to the present embodiment indicates the support degree instead of the association degree of the screen 101 illustrated in FIG. 10.

In the screen 221, the evaluations of the salesrooms are displayed, by using a vertical axis expressing the sales amount of each single salesroom, and a horizontal axis expressing the support degree. In the screen 221, the salesrooms are displayed such that a salesroom having a sales amount and a support degree which are both low belongs to a group 222, a salesroom having a high sales amount and a low support degree belongs to a group 223, a salesroom having a sales amount and a support degree which are both high belongs to a group 224, and a salesroom having a low sales amount and a high support degree belongs to a group 225.

Furthermore, for example, the screen generation unit 253 according to the present embodiment may include a detail information field 226 of a salesroom F in the screen 221, when the option 214d for displaying detail information of the salesroom F is selected in the input screen 221.

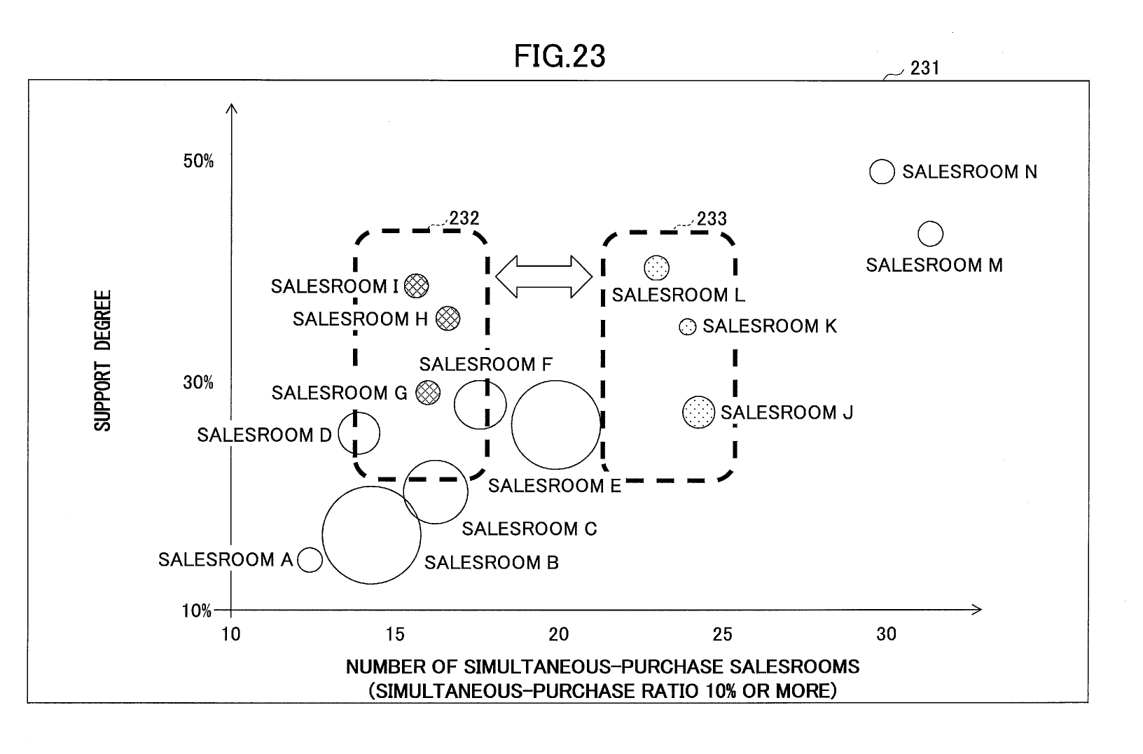

FIG. 23 is a second diagram for describing the display of evaluations of each salesroom according to a plurality of index values including a support degree. FIG. 23 illustrates an example of a screen 231 generated by the screen generation unit 253 in a case where the option 214a is selected in the pattern selection field 214 of the input screen 211, and the number of simultaneous-purchase salesrooms having a simultaneous-purchase ratio that is greater than or equal to a threshold, is selected as an index value other than the support degree. In the screen 231 according to the present embodiment, a support degree is indicated instead of the association degree of the screen 111 illustrated in FIG. 11.

In the screen 231 illustrated in FIG. 23, the vertical axis expresses the support degree, the horizontal axis expresses the number of simultaneous-purchase salesrooms having a simultaneous-purchase ratio of greater than or equal to 10%, and the sizes of the circles express the number of purchasing customers of each salesroom. That is to say, in the screen 231, the larger the circle of a salesroom, the greater the number of purchasing customers, and the smaller the circle of a salesroom, the less the number of purchasing customers.

Furthermore, in the screen 231, a comparison is made between salesrooms having approximately the same association degree but having a different number of simultaneous-purchasing customers. A group 232 and a group 233 in the screen 231 include salesrooms having an association degree of 750% through 1250%.

The number of simultaneous-purchase salesrooms (having a simultaneous-purchase ratio of greater than or equal to 10%) of a salesroom included in the group 232, is 12 through 17. The number of simultaneous-purchase salesrooms (having a simultaneous-purchase ratio of greater than or equal to 10%) of a salesroom included in the group 233, is 22 through 25. That is to say, salesrooms included in the group 233 have a higher number of simultaneous-purchase salesrooms at which an article is simultaneous-purchased by a high probability.

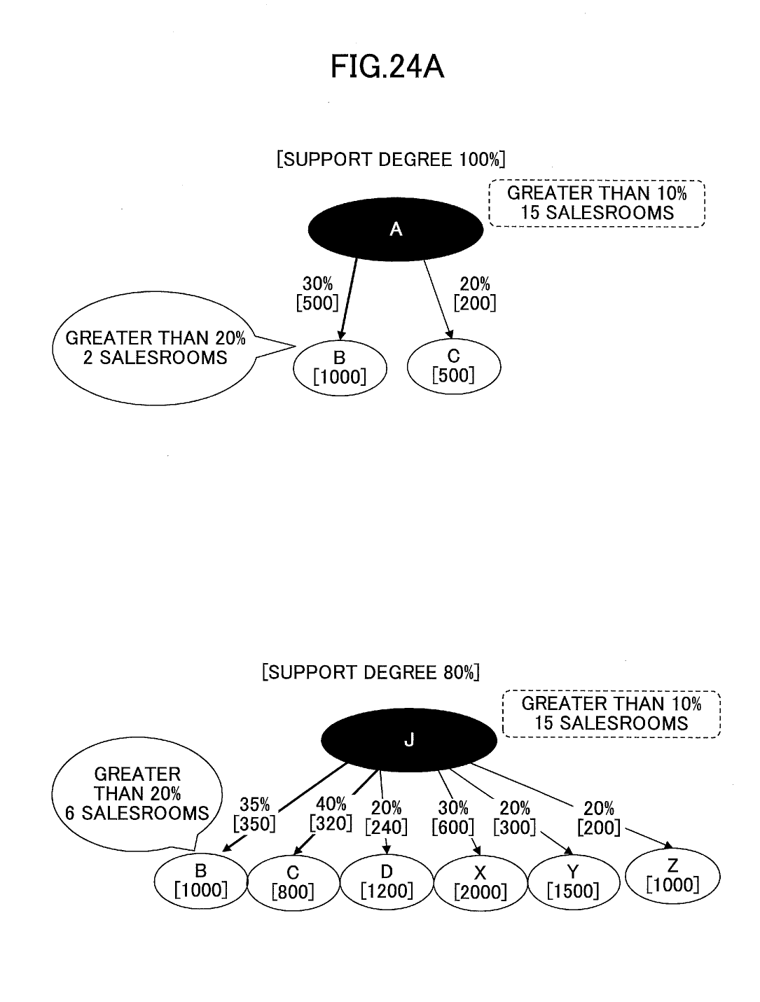

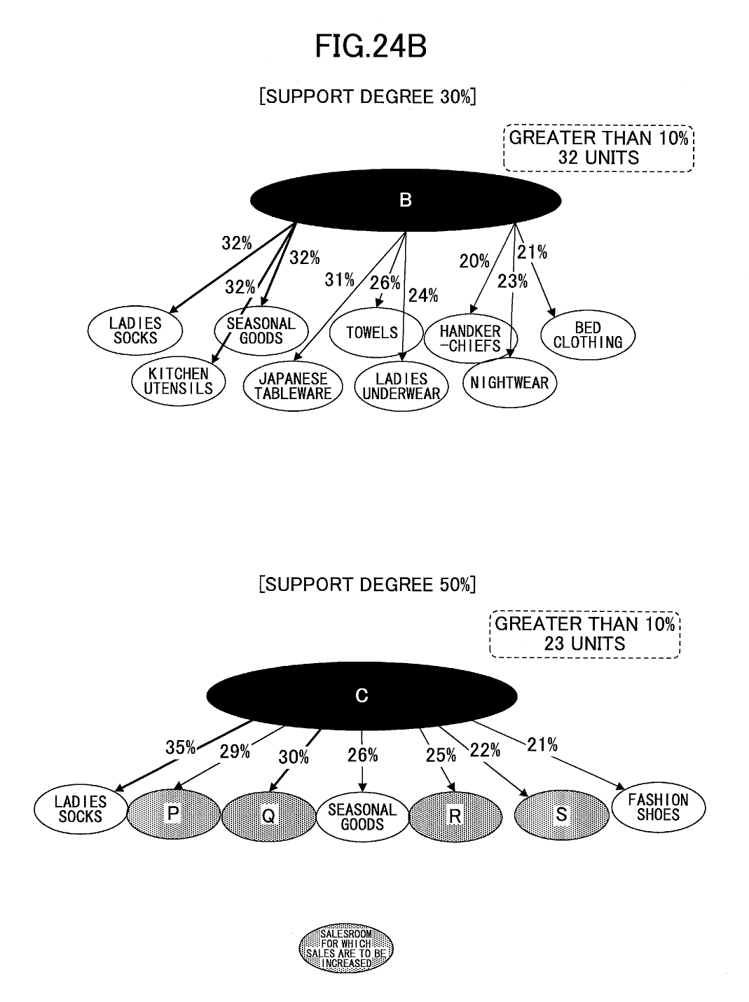

Next, a description is given of a case where the option 214b is selected in the pattern selection field 214 of the input screen 211. FIGS. 24A and 24B are for describing the connection between salesrooms based on the support degree and the simultaneous-purchase ratio. In FIGS. 24A and 24B, a support degree is indicated instead of the association degree of FIGS. 12A and 12B described in the first embodiment.

FIGS. 24A and 24B illustrate the interpretation of the connection between salesrooms based on the support degree and the simultaneous-purchase ratio. FIG. 24A is for describing the strength of the connection between salesrooms, and FIG. 24B is for describing the interpretation of the strength of the connection.

As illustrated in FIG. 24A, comparing a salesroom A having a support degree of 100% and a salesroom J having a support degree of 80%, the salesroom J has a larger number of simultaneous-purchase salesrooms having a high simultaneous-purchase ratio. Thus, compared to the salesroom A, the salesroom J has stronger connections with other salesrooms.

Next, a salesroom B having a support degree of 30%, and a salesroom C having a support degree of 50% illustrated in FIG. 24B, are considered.

As to the salesroom B, the number of simultaneous-purchase salesrooms having a simultaneous-purchase ratio of greater than or equal to 10%, is 32; however, there are no simultaneous-purchase salesrooms having a simultaneous-purchase ratio of greater than or equal to 20%. Thus, the salesroom B is connected with many salesrooms; however, there are no simultaneous-purchase salesrooms with which the salesroom B has a strong connection. That is to say, it is interpreted that the salesroom B is connected with a large indefinite number of salesrooms without any characteristic tendency.

As to the salesroom C, the number of simultaneous-purchase salesrooms having a simultaneous-purchase ratio of greater than or equal to 10%, is 23. In the present embodiment, for example, when a list of simultaneous-purchase salesrooms of the salesroom C includes a salesroom for which the sales is desired to increase, it is interpreted that it is possible to increase the sales of the corresponding salesroom by strengthening the connection with the salesroom C.

Furthermore, in the present embodiment, when the option 215b is selected in the pattern selection field 214 of the input screen 211, and 10% is input in the threshold entry field 213 of the simultaneous-purchase ratio, the screen generation unit 253 displays a screen in which a support degree is used instead of the association degree of FIG. 13 according to the first embodiment.

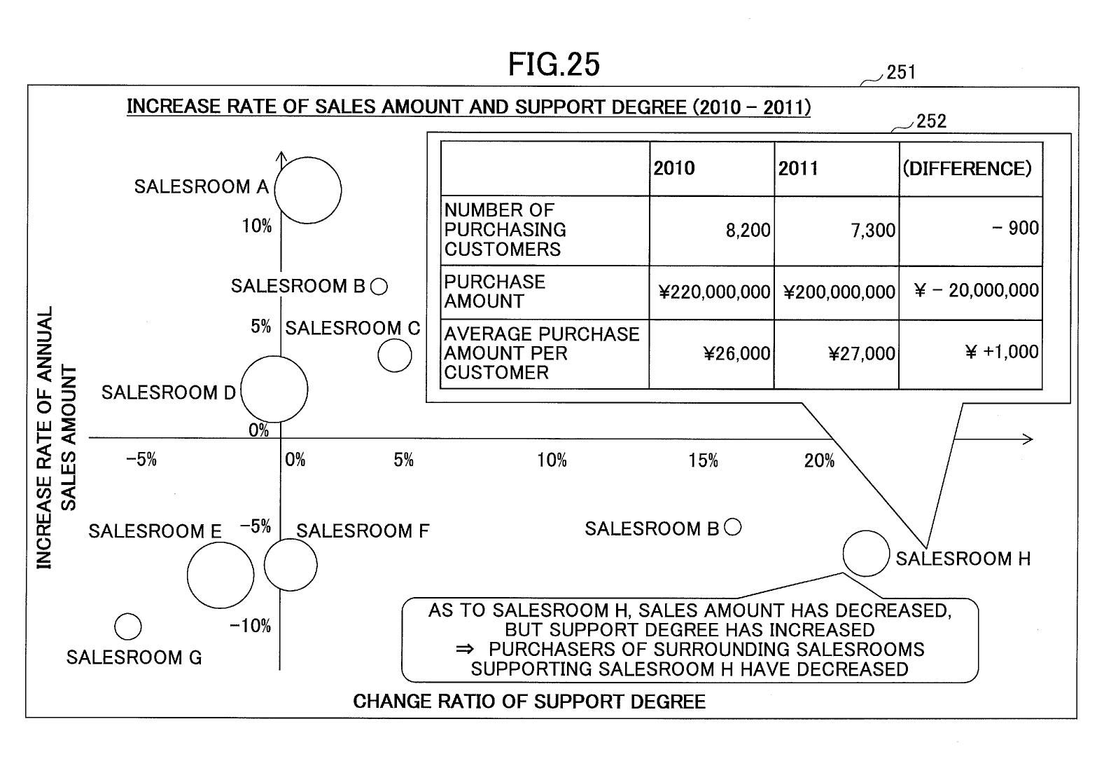

Next, with reference to FIG. 25, a description is given of a case where the option 214c in the input screen 211 is selected. FIG. 25 is for describing the display of changes in the support degree and the sales during predetermined two periods of each salesroom. In FIG. 25, the support degree is indicated instead of the association degree of FIG. 14 according to the first embodiment.

In a screen 261 of FIG. 25, the vertical axis expresses the increase rate of the annual sales amount of 2011 with respect to the annual sales amount of 2010, and the horizontal axis expresses the change ratio of the support degree of 2011 with respect to the support degree of 2010.

Furthermore, in the screen 261, a detail information field 262 of the salesroom H is displayed. In the detail information field 262, the number of purchasing customers of each year, the annual purchase amount, the average purchase amount per customer, and the difference between years, with respect to the salesroom H, are displayed. According to this detail information field 262, the number of customers and the annual purchase amount have decreased, but the average purchase amount per customer has increased.

Furthermore, as to the salesroom H, the annual sales amount has decreased compared to 2010, but the support degree has increased. Therefore, as to the salesroom H, it may be interpreted that “there is a decrease in the number of customers purchasing an article in another salesroom sending customers to the salesroom H”, and therefore it is possible to prevent the salesroom H from being undervalued due to the decrease in the annual sales amount.

As described above, in the present embodiment, the support degree is calculated, and the terminal device 300 is caused to display a screen relevant to the evaluation of each salesroom according to a plurality of index values including the support degree, and therefore it is possible to appropriately evaluate a salesroom.

### Third Embodiment

A third embodiment of the present invention is described below with reference to drawings. In the third embodiment, only the point of making evaluations by combining the association degree and the support degree is different from the first and second embodiments. Thus, in the following description of the third embodiment, only the points that are different from those of the first and second embodiments are described, and elements having the same functional configuration as those of the first and second embodiments are denoted by the same reference numerals, and descriptions thereof are omitted.

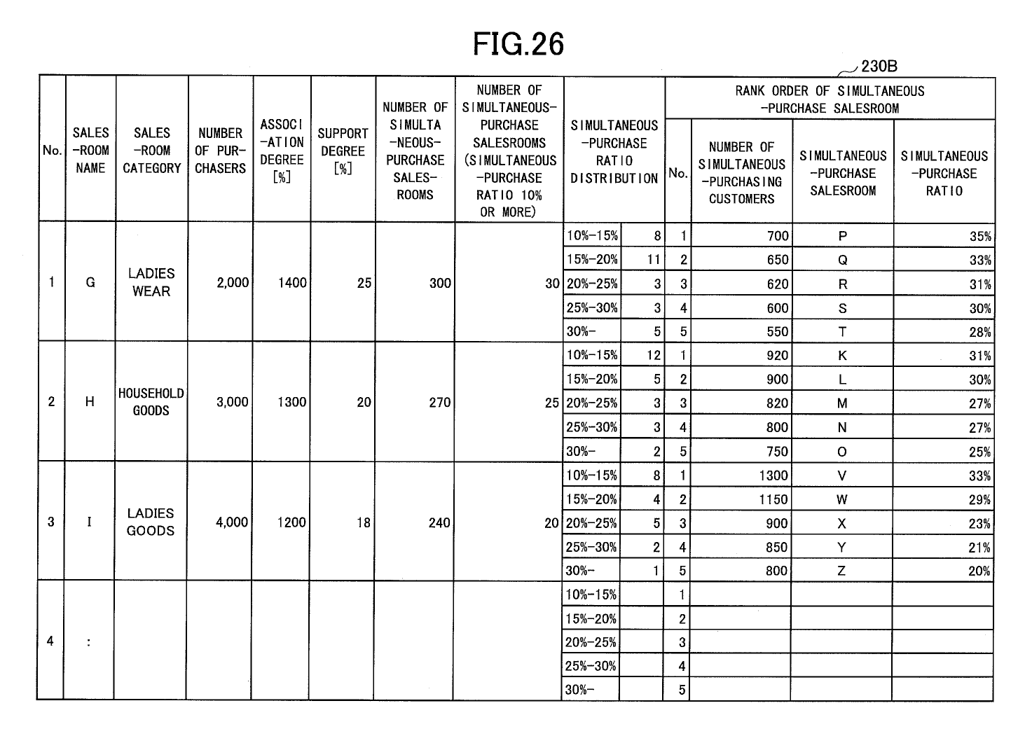

FIG. 26 illustrates an example of evaluation data according to the third embodiment. In evaluation data 230B illustrated in FIG. 26, both the association degree and the support degree are included. In the present embodiment, it is possible to cause the terminal device 300 to display a screen relevant to the evaluation of each salesroom corresponding to input with the use of the evaluation data 230B, in addition to displaying the evaluation using the evaluation data 230 and the evaluation data 230A.

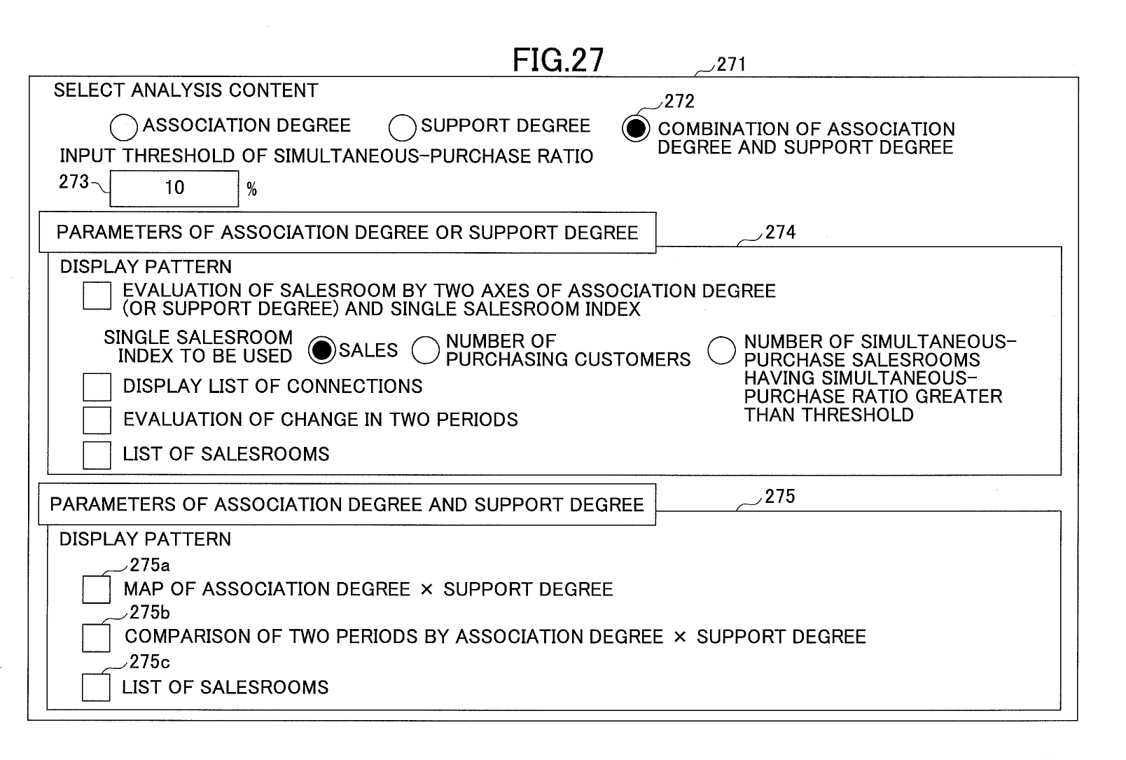

FIG. 27 illustrates an example of an input screen according to the third embodiment.

In an input screen 271 according to the present embodiment, a selection field 272 for selecting the analysis content for each salesroom, a threshold entry field 273 for inputting a threshold of the simultaneous-purchase ratio, and a pattern selection field 274 for selecting a display pattern of the evaluation data 230, 230A, are displayed. Furthermore, in the input screen 271 according to the present embodiment, a pattern selection field 275 for selecting a display pattern of the evaluation data 230B is displayed, in a case where a combination of the association degree and the support degree is selected as the analysis content.

In the pattern selection field 275, an option 275a and an option 275b for selecting a display pattern of the combination of the association degree and the support degree are included. Furthermore, in the pattern selection field 275 according to the present embodiment, for example, an option 275c for displaying details of the salesroom included in the evaluation data 230B may be displayed, other than the above options.

In the following, a description is given of cases where each of the option 275a and the option 275b are selected.

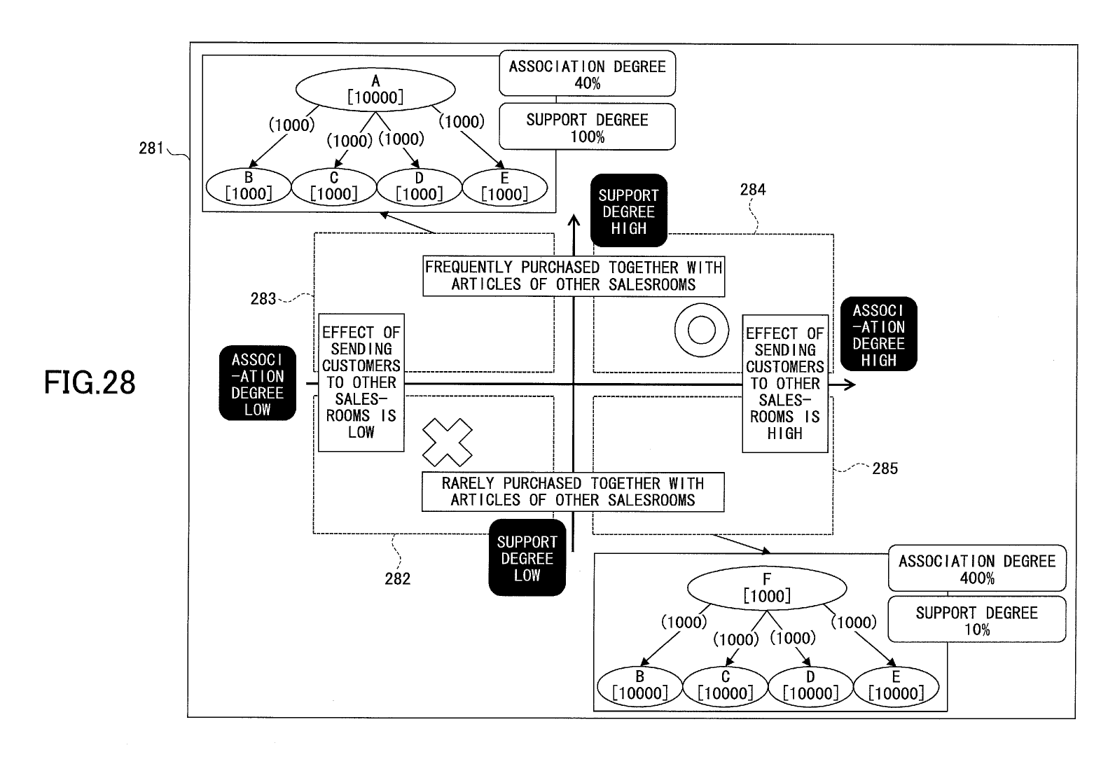

FIG. 28 is a first diagram for describing the display of evaluations of each salesroom according to a combination of the association degree and the support degree.

FIG. 28 illustrates an example of a screen 281 generated by the screen generation unit 253 in a case where the option 275a is selected in the pattern selection field 275 of the input screen 271.

In the screen 281, the vertical axis expresses the support degree and the horizontal axis expresses the association degree, and the salesrooms included in the evaluation data 230B are classified and displayed according to the support degree and the association degree. Note that the salesrooms displayed in the screen 281 are, for example, salesrooms having a simultaneous-purchase ratio that is greater than or equal to the threshold input in the threshold entry field 273.

In the screen 281, the salesrooms are displayed such that a salesroom having a support degree and an association degree which are both low belongs to a group 282, a salesroom having a high support degree and a low association degree belongs to a group 283, a salesroom having a support degree and an association degree which are both high belongs to a group 284, and a salesroom having a low support degree and a high association degree belongs to a group 285.

In the present embodiment, when the support degree is high, it means an article in the salesroom is often simultaneous-purchased with an article of another salesroom, and when the support degree is low, it means an article in the salesroom is rarely simultaneous-purchased with an article of another salesroom. Furthermore, in the present embodiment, when the association degree is high, it means that the salesroom has a high effect in sending customers to other salesrooms, and when the association degree is low, it means that the salesroom has a low effect in sending customers to other salesrooms.

Thus, articles of the salesrooms included in the group 282 are rarely simultaneous-purchased with articles of other salesrooms, and the salesrooms included in the group 282 have a low effect in sending customers to other salesrooms. Furthermore, articles of the salesrooms included in the group 283 are often simultaneous-purchased with articles of other salesrooms, but the salesrooms included in the group 282 have a low effect in sending customers to other salesrooms.

In the following, a description is given of a salesroom A included in the group 283. As to the salesroom A, the number of purchasing customers of the salesroom A alone is 10000, and the simultaneous-purchase salesrooms of the salesroom A are salesrooms B, C, D, E. The number of purchasing customers of each of the four simultaneous-purchase salesrooms B, C, D, E is 1000. Furthermore, the number of simultaneous-purchasing customers with respect to the salesroom A in each of the four salesrooms B, C, D, E is 1000.

In this case, it is interpreted that because the scale of the salesroom A is larger than the scale of the simultaneous-purchase salesrooms, articles of the salesroom A are often simultaneous-purchased with articles of other salesrooms.

Articles of the salesrooms included in the group 284 are often simultaneous-purchased with articles of other salesrooms, and the salesrooms included in the group 284 have a high effect in sending customers to other salesrooms.

Articles of the salesrooms included in the group 285 are rarely simultaneous-purchased with articles of other salesrooms, but the salesrooms included in the group 285 have a high effect in sending customers to other salesrooms.

In the following, a description is given of a salesroom F included in the group 285. As to the salesroom F, the number of purchasing customers of the salesroom F alone is 1000, and the simultaneous-purchase salesrooms of the salesroom F are salesrooms B, C, D, E. The number of purchasing customers of each of the four simultaneous-purchase salesrooms B, C, D, E is 10000. Furthermore, the number of simultaneous-purchasing customers with respect to the salesroom A in each of the four salesrooms B, C, D, E is 1000.

In this case, it is interpreted that because the scale of the salesroom F is smaller than the scale of the simultaneous-purchase salesrooms, the salesroom F sends many customers to other salesrooms.

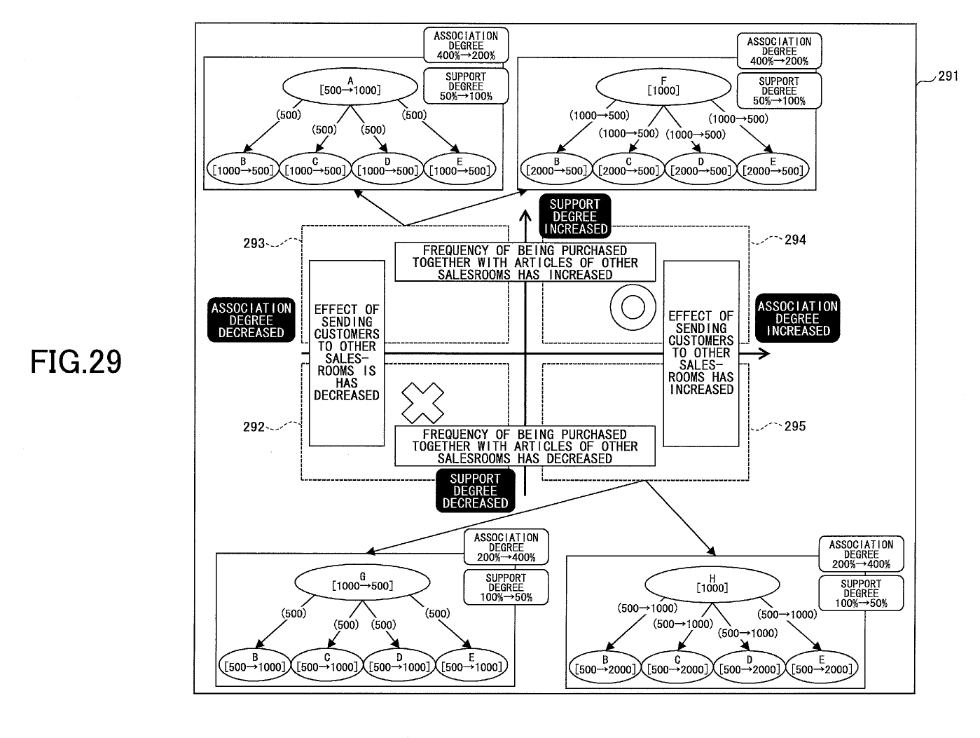

FIG. 29 is a second diagram for describing the display of evaluations of each salesroom according to a combination of the association degree and the support degree.

FIG. 29 illustrates an example of a screen 291 generated by the screen generation unit 253 in a case where the option 275b is selected in the pattern selection field 275 of the input screen 271.

In the screen 291, the vertical axis expresses the change ratio (increase/decrease) of the support degree and the horizontal axis expresses the change ratio (increase/decrease) of the association degree, and the salesrooms included in the evaluation data 230B are classified and displayed according to the change ratio of the support degree and the change ratio of the association degree.

In the screen 291, the salesrooms are displayed such that a salesroom having a support degree and an association degree which have both decreased belongs to a group 292, a salesroom having a support degree which has increased and an association degree which has decreased belongs to a group 293, a salesroom having a support degree and an association degree which have both increased belongs to a group 294, and a salesroom having a support degree which has decreased and an association degree which has increased belongs to a group 295.

In the present embodiment, when the support degree has increased, it means that the frequency of articles in the salesroom being simultaneous-purchased with articles of other salesrooms has increased, and when the support degree has decreased, it means that the frequency of articles in the salesroom being simultaneous-purchased with articles of other salesrooms has decreased. Furthermore, in the present embodiment, when the association degree has increased, it means that the effect of sending customers to other salesrooms has increased, and when the association degree has decreased, it means that the effect of sending customers to other salesrooms has decreased.

Thus, the frequency of articles of the salesrooms included in the group 292 being simultaneous-purchased with articles of other salesrooms has decreased, and the salesrooms included in the group 292 have decreased in terms of the effect in sending customers to other salesrooms. Furthermore, the frequency of articles of the salesrooms included in the group 293 being simultaneous-purchased with articles of other salesrooms has increased, but the salesrooms included in the group 293 have decreased in terms of the effect in sending customers to other salesrooms.

According to the classification of salesrooms according to the present embodiment, the following two interpretations are made with respect to the salesrooms included in the group 293.

In the following, a description is given of a first interpretation with respect to the salesrooms included in the group 293. As to the salesroom A included in the group 293, the number of purchasing customers of the salesroom A alone has increased from 500 to 1000. Furthermore, the number of purchasing customers of each of the four simultaneous-purchase salesrooms B, C, D, E of the salesroom A has decreased from 1000 to 500, and the number of simultaneous-purchasing customers with respect to the salesroom A in each of the salesrooms B, C, D, E has not changed.

In this case, an interpretation is made regarding the salesroom A that the number of purchasing customers of itself has increased, and the number of simultaneous-purchasing customers has not changed, and therefore the association degree has decreased. Furthermore, an interpretation is made regarding the salesroom A that the number of purchasing customers of each of the simultaneous-purchase salesrooms B, C, D, E has decreased, and the number of simultaneous-purchasing customers with respect to the salesroom A in each of the simultaneous-purchase salesrooms B, C, D, E has not changed, and therefore the support degree has increased.

Next, a description is given of a second interpretation with respect to the salesrooms included in the group 293. As to the salesroom F included in the group 293, the number of purchasing customers of the salesroom F alone is 1000 and has not changed. Furthermore, the number of purchasing customers of each of the four simultaneous-purchase salesrooms B, C, D, E of the salesroom F has decreased from 2000 to 500, and the number of simultaneous-purchasing customers with respect to the salesroom A in each of the four simultaneous-purchase salesrooms B, C, D, E has decreased from 1000 to 500.

In this case, an interpretation is made regarding the salesroom F that the number of purchasing customers of itself has not changed, and the number of simultaneous-purchasing customers has decreased, and therefore the association degree has decreased. Furthermore, an interpretation is made regarding the salesroom F that the ratio of decrease in the number of purchasing customers of each of the simultaneous-purchase salesrooms B, C, D, E is higher than the ratio of decrease in the number of simultaneous-purchasing customers of the salesroom A, and therefore the support degree has increased.

As to the salesrooms included in the group 294, the frequency of articles being simultaneous-purchased with articles of other salesrooms has increased, and the effect of sending customers to other salesrooms has increased.

As to the salesrooms included in the group 295, the frequency of articles being simultaneous-purchased with articles of other salesrooms has decreased, but the effect of sending customers to other salesrooms has increased.

According to the classification of salesrooms according to the present embodiment, the following two interpretations are made with respect to the salesrooms included in the group 295.

In the following, a description is given of a first interpretation with respect to the salesrooms included in the group 295. As to the salesroom G included in the group 295, the number of purchasing customers of the salesroom G alone has decreased from 1000 to 500. Furthermore, the number of purchasing customers of each of the four simultaneous-purchase salesrooms B, C, D, E of the salesroom G has increased from 500 to 1000. Furthermore, the number of simultaneous-purchasing customers with respect to the salesroom G in each of the simultaneous-purchase salesrooms B, C, D, E is 500 and has not changed.

In this case, an interpretation is made regarding the salesroom G that the number of purchasing customers of itself has decreased, and the number of simultaneous-purchasing customers has not changed, and therefore the association degree has increased. Furthermore, an interpretation is made regarding the salesroom G that the number of purchasing customers of each of the simultaneous-purchase salesrooms B, C, D, E has increased, and the number of simultaneous-purchasing customers with respect to the salesroom G in each of the simultaneous-purchase salesrooms B, C, D, E has not changed, and therefore the support degree has decreased.

Next, a description is given of a second interpretation with respect to the salesrooms included in the group 295. As to the salesroom H included in the group 295, the number of purchasing customers of the salesroom H is 1000 and has not changed. Furthermore, the number of purchasing customers of each of the four simultaneous-purchase salesrooms B, C, D, E of the salesroom H has increased from 500 to 2000. Furthermore, the number of simultaneous-purchasing customers with respect to the salesroom H in each of the four simultaneous-purchase salesrooms B, C, D, E has increased from 500 to 1000.

In this case, an interpretation is made regarding the salesroom H that the number of purchasing customers of itself has not changed, and the number of simultaneous-purchasing customers has increased, and therefore the association degree has decreased. Furthermore, an interpretation is made regarding the salesroom H that the ratio of increase in the number of purchasing customers of each of the simultaneous-purchase salesrooms B, C, D, E is higher than the ratio of increase in the number of simultaneous-purchasing customers of the salesroom H, and therefore the support degree has decreased.

As described above, in the present embodiment, by classifying and displaying the salesrooms based on the support degree and the association degree, it is possible to make the user correctly recognize the status of each salesroom, and to support the user to appropriately evaluate the salesroom.

According to an aspect of the embodiments, it is possible to provide support for appropriately evaluating salesrooms.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing an evaluation support program that causes a computer to execute a process comprising:
referring to purchase history data of articles in a plurality of salesrooms stored in a storage unit, and identifying a purchase status of articles purchased in a plurality of different salesrooms other than a first salesroom by purchasers included in a group of purchasers who have purchased articles in the first salesroom; and
calculating an association degree between the first salesroom and the plurality of different salesrooms, based on whether articles have been purchased in the plurality of different salesrooms as indicated by the purchase status.

2. The non-transitory computer-readable recording medium according to claim 1, wherein
the purchase status is a number of the purchasers who have purchased articles in the plurality of different salesrooms, among the group of purchasers, and
the calculating includes calculating the association degree by using a number of purchasers included in the group of purchasers and a number of the purchasers who have purchased articles in the plurality of different salesrooms.

3. The non-transitory computer-readable recording medium according to claim 1, wherein
the purchase history data includes a purchase amount of articles purchased by the purchasers,
the purchase status is the purchase amount of articles purchased in the plurality of different salesrooms by the purchasers who have purchased articles in the plurality of different salesrooms among the group of purchasers, and
the calculating includes calculating the association degree by using a purchase amount of articles purchased in the first salesroom by the group of purchasers, and a purchase amount of articles purchased in the plurality of different salesrooms by the purchasers included in the group of purchasers.

4. The non-transitory computer-readable recording medium according to claim 1, the process further comprising:
analyzing the purchase history data, generating evaluation data for each of the plurality of salesrooms including a sales amount of each of the plurality of salesrooms, and storing the evaluation data in the storage unit; and
classifying the plurality of salesrooms by referring to the association degree and the sales amount of each of the plurality of salesrooms.

5. The non-transitory computer-readable recording medium according to claim 4, wherein
the classifying includes classifying the plurality of salesrooms on a two-dimensional coordinate system constituted by an axis expressing the association degree and an axis expressing the sales amount of each of the plurality of salesrooms.

6. The non-transitory computer-readable recording medium according to claim 4, wherein
the classifying includes classifying the plurality of salesrooms for each predetermined range within an area in which the plurality of salesrooms are arranged.

7. The non-transitory computer-readable recording medium according to claim 1, wherein
the purchasers who have purchased articles in the first salesroom and the plurality of different salesrooms are purchasers who have purchased articles in the first salesroom and the plurality of different salesrooms on a same day.

8. The non-transitory computer-readable recording medium according to claim 1, the process further comprising:
displaying a tree in which the first salesroom and the plurality of different salesrooms related to the first salesroom are associated with each other, based on the association degree; and
prioritizing the displaying of salesrooms among the plurality of different salesrooms having a high association degree with the first salesroom.

9. The non-transitory computer-readable recording medium according to claim 8, wherein
the displaying includes displaying the tree including a predetermined salesroom, when the predetermined salesroom is selected.

10. An evaluation support device comprising:
a storage unit configured to store purchase history data of articles in a plurality of salesrooms;
an identification unit configured to refer to the storage unit and identify a purchase status of articles purchased in a plurality of different salesrooms other than a first salesroom by purchasers included in a group of purchasers who have purchased articles in the first salesroom; and
a calculation unit configured to calculate an association degree between the first salesroom and the plurality of different salesrooms, based on whether articles have been purchased in the plurality of different salesrooms as indicated by the purchase status.

11. An evaluation support method executed by a computer, comprising:
referring to purchase history data of articles in a plurality of salesrooms stored in a storage unit, and identifying a purchase status of articles purchased in a plurality of different salesrooms other than a first salesroom by purchasers included in a group of purchasers who have purchased articles in the first salesroom; and
calculating an association degree between the first salesroom and the plurality of different salesrooms, based on whether articles have been purchased in the plurality of different salesrooms as indicated by the purchase status.
